(19) United States
(12) Patent Application Publication
(10) Pub. No.: US 2025/0151041 A1
(43) Pub. Date: May 8, 2025

(54) SOUNDING METHOD AND DEVICE FOR PAIRING ANTENNA PORTS DISTRIBUTED IN DAS AND RECEPTION STA IN WIRELESS LAN SYSTEM

(71) Applicant: LG ELECTRONICS INC., Seoul (KR)

(72) Inventors: Eunsung PARK, Seoul (KR); Jinyoung CHUN, Seoul (KR); Jinsoo CHOI, Seoul (KR); Dongguk LIM, Seoul (KR); Insik JUNG, Seoul (KR)

(73) Assignee: LG ELECTRONICS INC., Seoul (KR)

(21) Appl. No.: 18/835,881

(22) PCT Filed: Jan. 31, 2023
(86) PCT No.: PCT/KR2023/001403

§ 371 Date: Aug. 5, 2024

(30) Foreign Application Priority Data
Feb. 23, 2022 (KR) 10-2022-0023775

(51) Int. Cl. H04W 72/0453; H04W 84/12

(52) U.S. Cl. CPC H04W 72/0453; H04W 84/12

(57) ABSTRACT

Provided is a sounding procedure for pairing antenna ports distributed in a DAS and a reception STA in a wireless LAN system. Specifically, the reception STA receives NDPA from a transmission STA. The reception STA receives an NDP from the transmission STA. The reception STA receives a trigger frame from the transmission STA. The reception STA transmits feedback information to the transmission STA. The transmission STA operates in a system in which a plurality of antenna ports are distributed. A first primary 20 MHz channel is a primary 20 MHz channel present in one BSS. Second primary 20 MHz channels are additional primary 20 MHz channels for the plurality of antenna ports, respectively.

### CROSS-REFERENCE TO RELATED APPLICATION(S)

This application is the National Stage filing under 35 U.S.C. 371 of International Application No. PCT/KR2023/001403, filed on Jan. 31, 2023, which claims the benefit of earlier filing date and right of priority to Korean Application No. 10-2022-0023775, filed on Feb. 23, 2022, the contents of which are all hereby incorporated by reference herein in their entireties.

### TECHNICAL FIELD

The present specification relates to a sounding technique for pairing between distributed antenna ports in a DAS and a receiving STA in a wireless LAN system, and more particularly, to a method and apparatus for measuring a channel state based on NDP for each antenna port in the DAS.

### BACKGROUND

A wireless local area network (WLAN) has been improved in various ways. For example, the IEEE 802.11ax standard proposed an improved communication environment using orthogonal frequency division multiple access (OFDMA) and downlink multi-user multiple input multiple output (DL MU MIMO) techniques.

The present specification proposes a technical feature that can be utilized in a new communication standard. For example, the new communication standard may be an extreme high throughput (EHT) standard which is currently being discussed. The EHT standard may use an increased bandwidth, an enhanced PHY layer protocol data unit (PPDU) structure, an enhanced sequence, a hybrid automatic repeat request (HARQ) scheme, or the like, which is newly proposed. The EHT standard may be called the IEEE 802.11be standard.

In a new WLAN standard, an increased number of spatial streams may be used. In this case, in order to properly use the increased number of spatial streams, a signaling technique in the WLAN system may need to be improved.

### SUMMARY

The present specification proposes a sounding method and apparatus for pairing between distributed antenna ports in a DAS and a receiving STA in a wireless LAN system.

An example of the present specification proposes a sounding method for pairing between distributed antenna ports in a DAS and a receiving STA.

The present embodiment may be performed in a network environment in which a next generation WLAN system (IEEE 802.11be or EHT WLAN system) is supported. The next generation wireless LAN system is a WLAN system that is enhanced from an 802.11ax system and may, therefore, satisfy backward compatibility with the 802.11ax system.

This embodiment is performed at a receiving STA, and the receiving STA may correspond to a station (STA) or an access point (AP). Conversely, the transmitting STA may correspond to an AP or STA. When the transmitting STA is an AP and the receiving STA is an STA, a PPDU described later may be a downlink PPDU. When the transmitting STA is an STA and the receiving STA is an AP, a PPDU described later may be an uplink PPDU.

This embodiment proposes a sounding procedure for determining pairing between distributed antenna ports and receiving STAs for DAS transmission.

A receiving station (STA) receives a Null Data Packet Announcement (NDPA) from a transmitting STA.

The receiving STA receives a Null Data Packet (NDP) from the transmitting STA.

The receiving STA receives a trigger frame from the transmitting STA.

The receiving STA transmits feedback information to the transmitting STA.

The transmitting STA operates in a system in which the plurality of antenna ports are distributed.

The first primary 20 MHz channel is a primary 20 MHz channel that exists within one Basic Service Set (BSS). The one BSS may be a BSS of the transmitting STA. The second primary 20 MHz channel is an additional primary 20 MHz channel for each of the plurality of antenna ports.

The NDPA is transmitted simultaneously through the plurality of antenna ports. That is, the NDPA may be transmitted simultaneously through all antenna ports in a bandwidth of the NDP.

The NDPA includes information on a bandwidth of the NDPA or the NDP, a number of the plurality of antenna ports, and a channel allocated to the plurality of antenna ports. The bandwidth of the NDPA or the NDP may be 20 MHz.

Previously, there was no definition of the DAS transmission technique, so there was a limit to improving performance such as throughput and latency by extending the transmission distance. However, according to the embodiment proposed in this specification, by measuring the channel state based on NDP for each antenna port, the DAS can be supported efficiently, and there is an effect of improving throughput and latency performance by extending the transmission distance. In addition, there is an advantage that the transmitting STA can send a signal to the receiving STA at a closer distance through the DAS.

### BRIEF DESCRIPTION OF THE DRAWINGS

FIG. 1 shows an example of a transmitting apparatus and/or receiving apparatus of the present specification.

FIG. 2 is a conceptual view illustrating the structure of a wireless local area network (WLAN).

FIG. 3 illustrates a general link setup process.

FIG. 4 illustrates an example of a PPDU used in an IEEE standard.

FIG. 5 illustrates a layout of resource units (RUs) used in a band of 20 MHz.

FIG. 6 illustrates a layout of RUs used in a band of 40 MHz.

FIG. 7 illustrates a layout of RUs used in a band of 80 MHz.

FIG. 8 illustrates a structure of an HE-SIG-B field.

FIG. 9 illustrates an example in which a plurality of user STAs are allocated to the same RU through a MU-MIMO scheme.

FIG. 10 illustrates an example of a PPDU used in the present specification.

FIG. 11 illustrates an example of a modified transmission device and/or receiving device of the present specification.

FIG. 12 shows the channelization of the 6 GHz band.

FIG. 13 shows the channelization of the 5 GHz band.

FIG. 14 shows the channelization of the 2.4 GHz band.

FIG. 15 shows channelization and extended channelization of the 6 GHz band of the 802.11be wireless LAN system.

FIG. 16 shows the format of the HE Operation element.

FIG. 17 shows the format of the 6 GHz Operation Information field.

FIG. 18 shows the format of a modified EHT Operation element.

FIG. 19 shows the format of the SST Operation element.

FIG. 20 shows the topology of the Multi-AP system.

FIG. 21 is a diagram of coordination of Multi-AP.

FIG. 22 shows interference avoidance steering of Multi-AP.

FIG. 23 shows AP coordination.

FIG. 24 shows coordinated beamforming.

FIG. 25 shows an example of Multi-AP.

FIG. 26 is a diagram comparing CAS and DAS.

FIG. 27 shows an example of EHT non-TB sounding.

FIG. 28 shows an example of EHT TB sounding.

FIG. 29 shows an example of an EHT NDP Announcement frame format.

FIG. 30 is a flowchart illustrating the operation of the transmitting apparatus/device according to the present embodiment.

FIG. 31 is a flowchart illustrating the operation of the receiving apparatus/device according to the present embodiment.

FIG. 32 is a flow diagram illustrating a procedure in which a transmitting STA measures a channel state for pairing between a distributed antenna port and a receiving STA in a DAS according to this embodiment.

FIG. 33 is a flow diagram illustrating a procedure in which a receiving STA feed backs a channel state for pairing between a receiving STA and a distributed antenna port in a DAS according to this embodiment.

### DETAILED DESCRIPTION

In the present specification, “A or B” may mean “only A”, “only B” or “both A and B”. In other words, in the present specification, “A or B” may be interpreted as “A and/or B”. For example, in the present specification, “A, B, or C” may mean “only A”, “only B”, “only C”, or “any combination of A, B, C”.

A slash (/) or comma used in the present specification may mean “and/or”. For example, “A/B” may mean “A and/or B”. Accordingly, “A/B” may mean “only A”, “only B”, or “both A and B”. For example, “A, B, C” may mean “A, B, or C”.

In the present specification, “at least one of A and B” may mean “only A”, “only B”, or “both A and B”. In addition, in the present specification, the expression “at least one of A or B” or “at least one of A and/or B” may be interpreted as “at least one of A and B”.

In addition, in the present specification, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present specification may mean “for example”. Specifically, when indicated as “control information (EHT-signal)”, it may denote that “EHT-signal” is proposed as an example of the “control information”. In other words, the “control information” of the present specification is not limited to “EHT-signal”, and “EHT-signal” may be proposed as an example of the “control information”. In addition, when indicated as “control information (i.e., EHT-signal)”, it may also mean that “EHT-signal” is proposed as an example of the “control information”.

Technical features described individually in one figure in the present specification may be individually implemented, or may be simultaneously implemented.

The following example of the present specification may be applied to various wireless communication systems. For example, the following example of the present specification may be applied to a wireless local area network (WLAN) system. For example, the present specification may be applied to the IEEE 802.11a/g/n/ac standard or the IEEE 802.11ax standard. In addition, the present specification may also be applied to the newly proposed EHT standard or IEEE 802.11be standard. In addition, the example of the present specification may also be applied to a new WLAN standard enhanced from the EHT standard or the IEEE 802.11be standard. In addition, the example of the present specification may be applied to a mobile communication system. For example, it may be applied to a mobile communication system based on long term evolution (LTE) depending on a 3^{rd} generation partnership project (3GPP) standard and based on evolution of the LTE. In addition, the example of the present specification may be applied to a communication system of a 5G NR standard based on the 3GPP standard.

Hereinafter, in order to describe a technical feature of the present specification, a technical feature applicable to the present specification will be described.

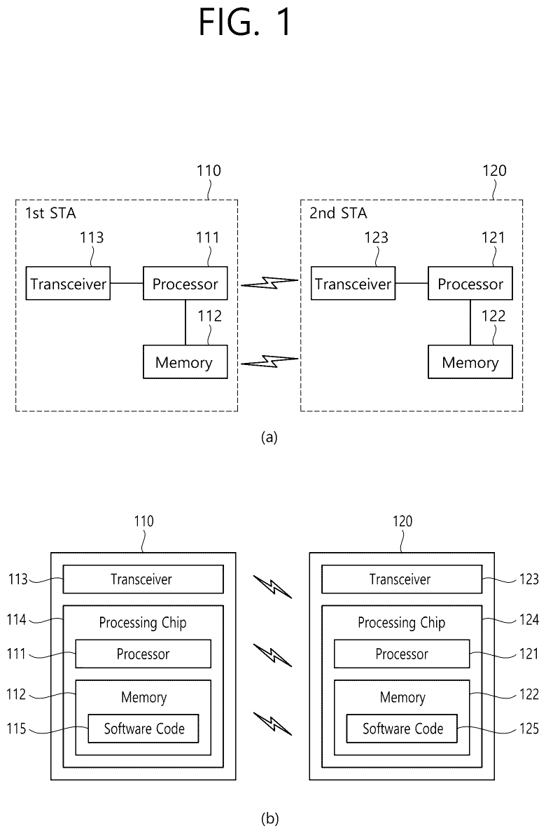

FIG. 1 shows an example of a transmitting apparatus and/or receiving apparatus of the present specification.

In the example of FIG. 1, various technical features described below may be performed. FIG. 1 relates to at least one station (STA). For example, STAs 110 and 120 of the present specification may also be called in various terms such as a mobile terminal, a wireless device, a wireless transmit/receive unit (WTRU), a user equipment (UE), a mobile station (MS), a mobile subscriber unit, or simply a user. The STAs 110 and 120 of the present specification may also be called in various terms such as a network, a base station, a node-B, an access point (AP), a repeater, a router, a relay, or the like. The STAs 110 and 120 of the present specification may also be referred to as various names such as a receiving apparatus, a transmitting apparatus, a receiving STA, a transmitting STA, a receiving device, a transmitting device, or the like.

For example, the STAs 110 and 120 may serve as an AP or a non-AP. That is, the STAs 110 and 120 of the present specification may serve as the AP and/or the non-AP.

The STAs 110 and 120 of the present specification may support various communication standards together in addition to the IEEE 802.11 standard. For example, a communication standard (e.g., LTE, LTE-A, 5G NR standard) or the like based on the 3GPP standard may be supported. In addition, the STA of the present specification may be implemented as various devices such as a mobile phone, a vehicle, a personal computer, or the like. In addition, the STA of the present specification may support communication for various communication services such as voice calls, video calls, data communication, and self-driving (autonomous-driving), or the like.

The STAs 110 and 120 of the present specification may include a medium access control (MAC) conforming to the IEEE 802.11 standard and a physical layer interface for a radio medium.

The STAs 110 and 120 will be described below with reference to a sub-figure (a) of FIG. 1.

The first STA 110 may include a processor 111, a memory 112, and a transceiver 113. The illustrated process, memory, and transceiver may be implemented individually as separate chips, or at least two blocks/functions may be implemented through a single chip.

The transceiver 113 of the first STA performs a signal transmission/reception operation. Specifically, an IEEE 802.11 packet (e.g., IEEE 802.11 a/b/g/n/ac/ax/be, etc.) may be transmitted/received.

For example, the first STA 110 may perform an operation intended by an AP. For example, the processor 111 of the AP may receive a signal through the transceiver 113, process a reception (RX) signal, generate a transmission (TX) signal, and provide control for signal transmission. The memory 112 of the AP may store a signal (e.g., RX signal) received through the transceiver 113, and may store a signal (e.g., TX signal) to be transmitted through the transceiver.

For example, the second STA 120 may perform an operation intended by a non-AP STA. For example, a transceiver 123 of a non-AP performs a signal transmission/reception operation. Specifically, an IEEE 802.11 packet (e.g., IEEE 802.11a/b/g/n/ac/ax/be packet, etc.) may be transmitted/received.

For example, a processor 121 of the non-AP STA may receive a signal through the transceiver 123, process an RX signal, generate a TX signal, and provide control for signal transmission. A memory 122 of the non-AP STA may store a signal (e.g., RX signal) received through the transceiver 123, and may store a signal (e.g., TX signal) to be transmitted through the transceiver.

For example, an operation of a device indicated as an AP in the specification described below may be performed in the first STA 110 or the second STA 120. For example, if the first STA 110 is the AP, the operation of the device indicated as the AP may be controlled by the processor 111 of the first STA 110, and a related signal may be transmitted or received through the transceiver 113 controlled by the processor 111 of the first STA 110. In addition, control information related to the operation of the AP or a TX/RX signal of the AP may be stored in the memory 112 of the first STA 110. In addition, if the second STA 120 is the AP, the operation of the device indicated as the AP may be controlled by the processor 121 of the second STA 120, and a related signal may be transmitted or received through the transceiver 123 controlled by the processor 121 of the second STA 120. In addition, control information related to the operation of the AP or a TX/RX signal of the AP may be stored in the memory 122 of the second STA 120.

For example, in the specification described below, an operation of a device indicated as a non-AP (or user-STA) may be performed in the first STA 110 or the second STA 120. For example, if the second STA 120 is the non-AP, the operation of the device indicated as the non-AP may be controlled by the processor 121 of the second STA 120, and a related signal may be transmitted or received through the transceiver 123 controlled by the processor 121 of the second STA 120. In addition, control information related to the operation of the non-AP or a TX/RX signal of the non-AP may be stored in the memory 122 of the second STA 120. For example, if the first STA 110 is the non-AP, the operation of the device indicated as the non-AP may be controlled by the processor 111 of the first STA 110, and a related signal may be transmitted or received through the transceiver 113 controlled by the processor 111 of the first STA 110. In addition, control information related to the operation of the non-AP or a TX/RX signal of the non-AP may be stored in the memory 112 of the first STA 110.

In the specification described below, a device called a (transmitting/receiving) STA, a first STA, a second STA, a STA1, a STA2, an AP, a first AP, a second AP, an AP1, an AP2, a (transmitting/receiving) terminal, a (transmitting/receiving) device, a (transmitting/receiving) apparatus, a network, or the like may imply the STAs 110 and 120 of FIG. 1. For example, a device indicated as, without a specific reference numeral, the (transmitting/receiving) STA, the first STA, the second STA, the STA1, the STA2, the AP, the first AP, the second AP, the AP1, the AP2, the (transmitting/receiving) terminal, the (transmitting/receiving) device, the (transmitting/receiving) apparatus, the network, or the like may imply the STAs 110 and 120 of FIG. 1. For example, in the following example, an operation in which various STAs transmit/receive a signal (e.g., a PPDU) may be performed in the transceivers 113 and 123 of FIG. 1. In addition, in the following example, an operation in which various STAs generate a TX/RX signal or perform data processing and computation in advance for the TX/RX signal may be performed in the processors 111 and 121 of FIG. 1. For example, an example of an operation for generating the TX/RX signal or performing the data processing and computation in advance may include: 1) an operation of determining/obtaining/configuring/computing/decoding/encoding bit information of a sub-field (SIG, STF, LTF, Data) included in a PPDU; 2) an operation of determining/configuring/obtaining a time resource or frequency resource (e.g., a subcarrier resource) or the like used for the sub-field (SIG, STF, LTF, Data) included the PPDU; 3) an operation of determining/configuring/obtaining a specific sequence (e.g., a pilot sequence, an STF/LTF sequence, an extra sequence applied to SIG) or the like used for the sub-field (SIG, STF, LTF, Data) field included in the PPDU; 4) a power control operation and/or power saving operation applied for the STA; and 5) an operation related to determining/obtaining/configuring/decoding/encoding or the like of an ACK signal. In addition, in the following example, a variety of information used by various STAs for determining/obtaining/configuring/computing/decoding/decoding a TX/RX signal (e.g., information related to a field/subfield/control field/parameter/power or the like) may be stored in the memories 112 and 122 of FIG. 1.

The aforementioned device/STA of the sub-figure (a) of FIG. 1 may be modified as shown in the sub-figure (b) of FIG. 1. Hereinafter, the STAs 110 and 120 of the present specification will be described based on the sub-figure (b) of FIG. 1.

For example, the transceivers 113 and 123 illustrated in the sub-figure (b) of FIG. 1 may perform the same function as the aforementioned transceiver illustrated in the sub-figure (a) of FIG. 1. For example, processing chips 114 and 124 illustrated in the sub-figure (b) of FIG. 1 may include the processors 111 and 121 and the memories 112 and 122. The processors 111 and 121 and memories 112 and 122 illustrated in the sub-figure (b) of FIG. 1 may perform the same function as the aforementioned processors 111 and 121 and memories 112 and 122 illustrated in the sub-figure (a) of FIG. 1.

A mobile terminal, a wireless device, a wireless transmit/receive unit (WTRU), a user equipment (UE), a mobile station (MS), a mobile subscriber unit, a user, a user STA, a network, a base station, a Node-B, an access point (AP), a repeater, a router, a relay, a receiving unit, a transmitting unit, a receiving STA, a transmitting STA, a receiving device, a transmitting device, a receiving apparatus, and/or a transmitting apparatus, which are described below, may imply the STAs 110 and 120 illustrated in the sub-figure (a)/(b) of FIG. 1, or may imply the processing chips 114 and 124 illustrated in the sub-figure (b) of FIG. 1. That is, a technical feature of the present specification may be performed in the STAs 110 and 120 illustrated in the sub-figure (a)/(b) of FIG. 1, or may be performed only in the processing chips 114 and 124 illustrated in the sub-figure (b) of FIG. 1. For example, a technical feature in which the transmitting STA transmits a control signal may be understood as a technical feature in which a control signal generated in the processors 111 and 121 illustrated in the sub-figure (a)/(b) of FIG. 1 is transmitted through the transceivers 113 and 123 illustrated in the sub-figure (a)/(b) of FIG. 1. Alternatively, the technical feature in which the transmitting STA transmits the control signal may be understood as a technical feature in which the control signal to be transferred to the transceivers 113 and 123 is generated in the processing chips 114 and 124 illustrated in the sub-figure (b) of FIG. 1.

For example, a technical feature in which the receiving STA receives the control signal may be understood as a technical feature in which the control signal is received by means of the transceivers 113 and 123 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (a) of FIG. 1 is obtained by the processors 111 and 121 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (b) of FIG. 1 is obtained by the processing chips 114 and 124 illustrated in the sub-figure (b) of FIG. 1.

Referring to the sub-figure (b) of FIG. 1, software codes 115 and 125 may be included in the memories 112 and 122. The software codes 115 and 126 may include instructions for controlling an operation of the processors 111 and 121. The software codes 115 and 125 may be included as various programming languages.

The processors 111 and 121 or processing chips 114 and 124 of FIG. 1 may include an application-specific integrated circuit (ASIC), other chipsets, a logic circuit and/or a data processing device. The processor may be an application processor (AP). For example, the processors 111 and 121 or processing chips 114 and 124 of FIG. 1 may include at least one of a digital signal processor (DSP), a central processing unit (CPU), a graphics processing unit (GPU), and a modulator and demodulator (modem). For example, the processors 111 and 121 or processing chips 114 and 124 of FIG. 1 may be SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or processors enhanced from these processors.

In the present specification, an uplink may imply a link for communication from a non-AP STA to an SP STA, and an uplink PPDU/packet/signal or the like may be transmitted through the uplink. In addition, in the present specification, a downlink may imply a link for communication from the AP STA to the non-AP STA, and a downlink PPDU/packet/signal or the like may be transmitted through the downlink.

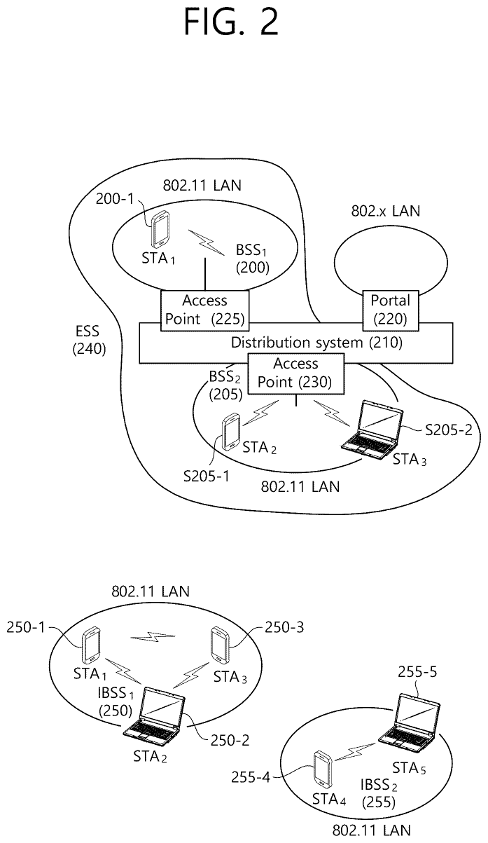

FIG. 2 is a conceptual view illustrating the structure of a wireless local area network (WLAN).

An upper part of FIG. 2 illustrates the structure of an infrastructure basic service set (BSS) of institute of electrical and electronic engineers (IEEE) 802.11.

Referring the upper part of FIG. 2, the wireless LAN system may include one or more infrastructure BSSs 200 and 205 (hereinafter, referred to as BSS). The BSSs 200 and 205 as a set of an AP and a STA such as an access point (AP) 225 and a station (STA1) 200-1 which are successfully synchronized to communicate with each other are not concepts indicating a specific region. The BSS 205 may include one or more STAs 205-1 and 205-2 which may be joined to one AP 230.

The BSS may include at least one STA, APs providing a distribution service, and a distribution system (DS) 210 connecting multiple APs.

The distribution system 210 may implement an extended service set (ESS) 240 extended by connecting the multiple BSSs 200 and 205. The ESS 240 may be used as a term indicating one network configured by connecting one or more APs 225 or 230 through the distribution system 210. The AP included in one ESS 240 may have the same service set identification (SSID).

A portal 220 may serve as a bridge which connects the wireless LAN network (IEEE 802.11) and another network (e.g., 802.X).

In the BSS illustrated in the upper part of FIG. 2, a network between the APs 225 and 230 and a network between the APs 225 and 230 and the STAs 200-1, 205-1, and 205-2 may be implemented. However, the network is configured even between the STAs without the APs 225 and 230 to perform communication. A network in which the communication is performed by configuring the network even between the STAs without the APs 225 and 230 is defined as an Ad-Hoc network or an independent basic service set (IBSS).

A lower part of FIG. 2 illustrates a conceptual view illustrating the IBSS.

Referring to the lower part of FIG. 2, the IBSS is a BSS that operates in an Ad-Hoc mode. Since the IBSS does not include the access point (AP), a centralized management entity that performs a management function at the center does not exist. That is, in the IBSS, STAs 250-1, 250-2, 250-3, 255-4, and 255-5 are managed by a distributed manner. In the IBSS, all STAs 250-1, 250-2, 250-3, 255-4, and 255-5 may be constituted by movable STAs and are not permitted to access the DS to constitute a self-contained network.

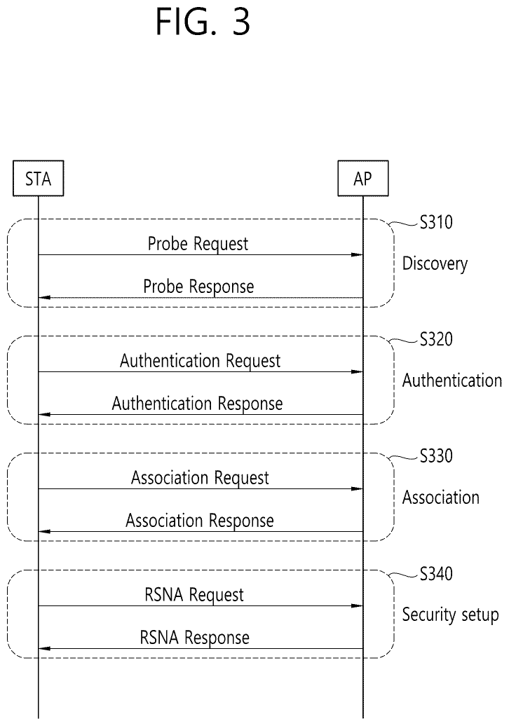

FIG. 3 illustrates a general link setup process.

In S310, a STA may perform a network discovery operation. The network discovery operation may include a scanning operation of the STA. That is, to access a network, the STA needs to discover a participating network. The STA needs to identify a compatible network before participating in a wireless network, and a process of identifying a network present in a particular area is referred to as scanning. Scanning methods include active scanning and passive scanning.

FIG. 3 illustrates a network discovery operation including an active scanning process. In active scanning, a STA performing scanning transmits a probe request frame and waits for a response to the probe request frame in order to identify which AP is present around while moving to channels. A responder transmits a probe response frame as a response to the probe request frame to the STA having transmitted the probe request frame. Here, the responder may be a STA that transmits the last beacon frame in a BSS of a channel being scanned. In the BSS, since an AP transmits a beacon frame, the AP is the responder. In an IBSS, since STAs in the IBSS transmit a beacon frame in turns, the responder is not fixed. For example, when the STA transmits a probe request frame via channel 1 and receives a probe response frame via channel 1, the STA may store BSS-related information included in the received probe response frame, may move to the next channel (e.g., channel 2), and may perform scanning (e.g., transmits a probe request and receives a probe response via channel 2) by the same method.

Although not shown in FIG. 3, scanning may be performed by a passive scanning method. In passive scanning, a STA performing scanning may wait for a beacon frame while moving to channels. A beacon frame is one of management frames in IEEE 802.11 and is periodically transmitted to indicate the presence of a wireless network and to enable the STA performing scanning to find the wireless network and to participate in the wireless network. In a BSS, an AP serves to periodically transmit a beacon frame. In an IBSS, STAs in the IBSS transmit a beacon frame in turns. Upon receiving the beacon frame, the STA performing scanning stores information related to a BSS included in the beacon frame and records beacon frame information in each channel while moving to another channel. The STA having received the beacon frame may store BSS-related information included in the received beacon frame, may move to the next channel, and may perform scanning in the next channel by the same method.

After discovering the network, the STA may perform an authentication process in S320. The authentication process may be referred to as a first authentication process to be clearly distinguished from the following security setup operation in S340. The authentication process in S320 may include a process in which the STA transmits an authentication request frame to the AP and the AP transmits an authentication response frame to the STA in response. The authentication frames used for an authentication request/response are management frames.

The authentication frames may include information related to an authentication algorithm number, an authentication transaction sequence number, a status code, a challenge text, a robust security network (RSN), and a finite cyclic group.

The STA may transmit the authentication request frame to the AP. The AP may determine whether to allow the authentication of the STA based on the information included in the received authentication request frame. The AP may provide the authentication processing result to the STA via the authentication response frame.

When the STA is successfully authenticated, the STA may perform an association process in S330. The association process includes a process in which the STA transmits an association request frame to the AP and the AP transmits an association response frame to the STA in response. The association request frame may include, for example, information related to various capabilities, a beacon listen interval, a service set identifier (SSID), a supported rate, a supported channel, RSN, a mobility domain, a supported operating class, a traffic indication map (TIM) broadcast request, and an interworking service capability. The association response frame may include, for example, information related to various capabilities, a status code, an association ID (AID), a supported rate, an enhanced distributed channel access (EDCA) parameter set, a received channel power indicator (RCPI), a received signal-to-noise indicator (RSNI), a mobility domain, a timeout interval (association comeback time), an overlapping BSS scanning parameter, a TIM broadcast response, and a QoS map.

In S340, the STA may perform a security setup process. The security setup process in S340 may include a process of setting up a private key through four-way handshaking, for example, through an extensible authentication protocol over LAN (EAPOL) frame.

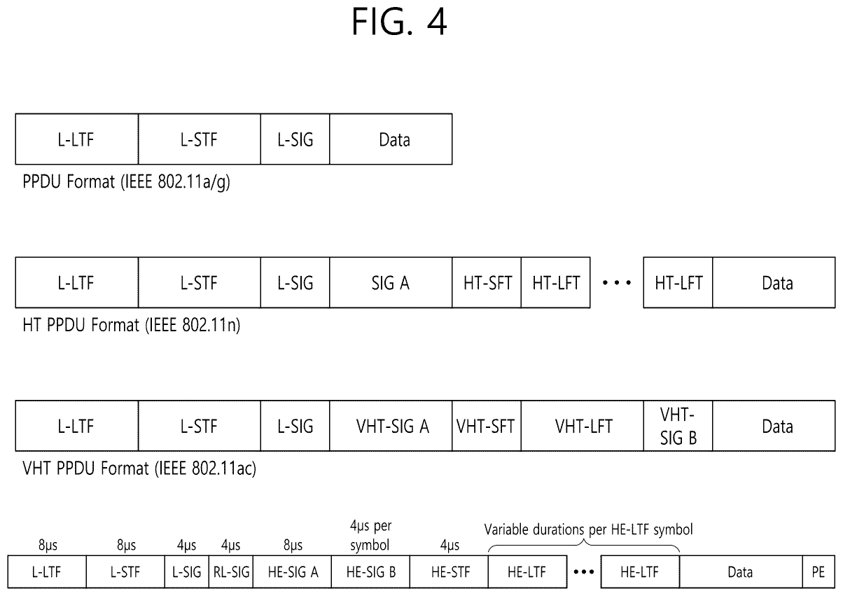

FIG. 4 illustrates an example of a PPDU used in an IEEE standard.

As illustrated, various types of PHY protocol data units (PPDUs) are used in IEEE a/g/n/ac standards. Specifically, an LTF and a STF include a training signal, a SIG-A and a SIG-B include control information for a receiving STA, and a data field includes user data corresponding to a PSDU (MAC PDU/aggregated MAC PDU).

FIG. 4 also includes an example of an HE PPDU according to IEEE 802.11ax. The HE PPDU according to FIG. 4 is an illustrative PPDU for multiple users. An HE-SIG-B may be included only in a PPDU for multiple users, and an HE-SIG-B may be omitted in a PPDU for a single user.

As illustrated in FIG. 4, the HE-PPDU for multiple users (MUs) may include a legacy-short training field (L-STF), a legacy-long training field (L-LTF), a legacy-signal (L-SIG), a high efficiency-signal A (HE-SIG A), a high efficiency-signal-B (HE-SIG B), a high efficiency-short training field (HE-STF), a high efficiency-long training field (HE-LTF), a data field (alternatively, an MAC payload), and a packet extension (PE) field. The respective fields may be transmitted for illustrated time periods (i.e., 4 or 8 μs).

Hereinafter, a resource unit (RU) used for a PPDU is described. An RU may include a plurality of subcarriers (or tones). An RU may be used to transmit a signal to a plurality of STAs according to OFDMA. Further, an RU may also be defined to transmit a signal to one STA. An RU may be used for an STF, an LTF, a data field, or the like.

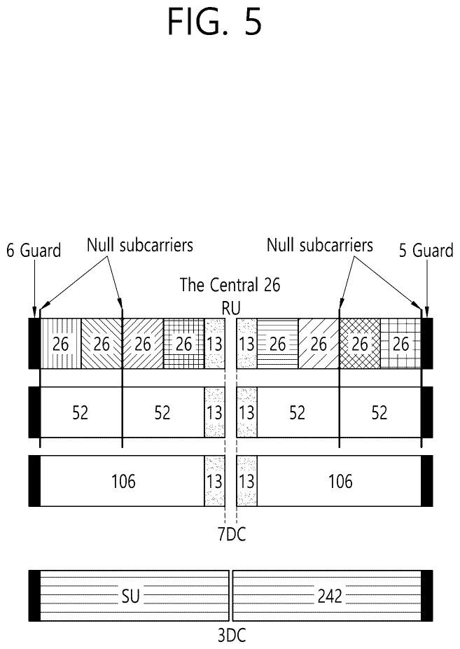

FIG. 5 illustrates a layout of resource units (RUs) used in a band of 20 MHz.

As illustrated in FIG. 5, resource units (RUs) corresponding to different numbers of tones (i.e., subcarriers) may be used to form some fields of an HE-PPDU. For example, resources may be allocated in illustrated RUs for an HE-STF, an HE-LTF, and a data field.

As illustrated in the uppermost part of FIG. 5, a 26-unit (i.e., a unit corresponding to 26 tones) may be disposed. Six tones may be used for a guard band in the leftmost band of the 20 MHz band, and five tones may be used for a guard band in the rightmost band of the 20 MHz band. Further, seven DC tones may be inserted in a center band, that is, a DC band, and a 26-unit corresponding to 13 tones on each of the left and right sides of the DC band may be disposed. A 26-unit, a 52-unit, and a 106-unit may be allocated to other bands. Each unit may be allocated for a receiving STA, that is, a user.

The layout of the RUs in FIG. 5 may be used not only for a multiple users (MUs) but also for a single user (SU), in which case one 242-unit may be used and three DC tones may be inserted as illustrated in the lowermost part of FIG. 5.

Although FIG. 5 proposes RUs having various sizes, that is, a 26-RU, a 52-RU, a 106-RU, and a 242-RU, specific sizes of RUs may be extended or increased. Therefore, the present embodiment is not limited to the specific size of each RU (i.e., the number of corresponding tones).

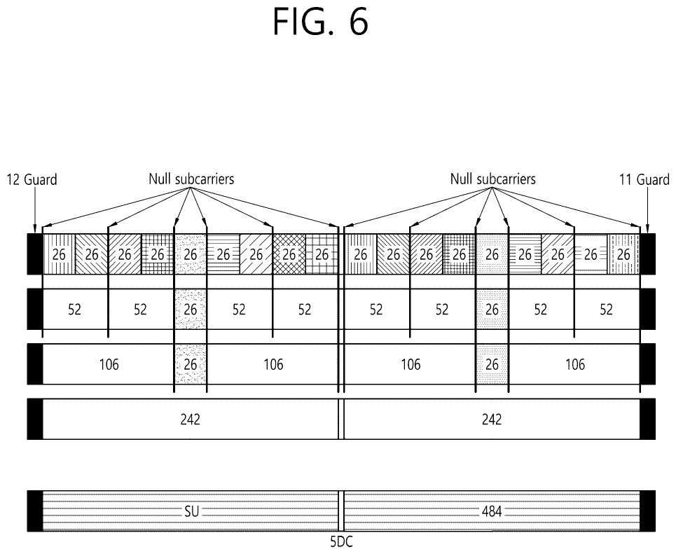

FIG. 6 illustrates a layout of RUs used in a band of 40 MHz.

Similarly to FIG. 5 in which RUs having various sizes are used, a 26-RU, a 52-RU, a 106-RU, a 242-RU, a 484-RU, and the like may be used in an example of FIG. 6. Further, five DC tones may be inserted in a center frequency, 12 tones may be used for a guard band in the leftmost band of the 40 MHz band, and 11 tones may be used for a guard band in the rightmost band of the 40 MHz band.

As illustrated in FIG. 6, when the layout of the RUs is used for a single user, a 484-RU may be used. The specific number of RUs may be changed similarly to FIG. 5.

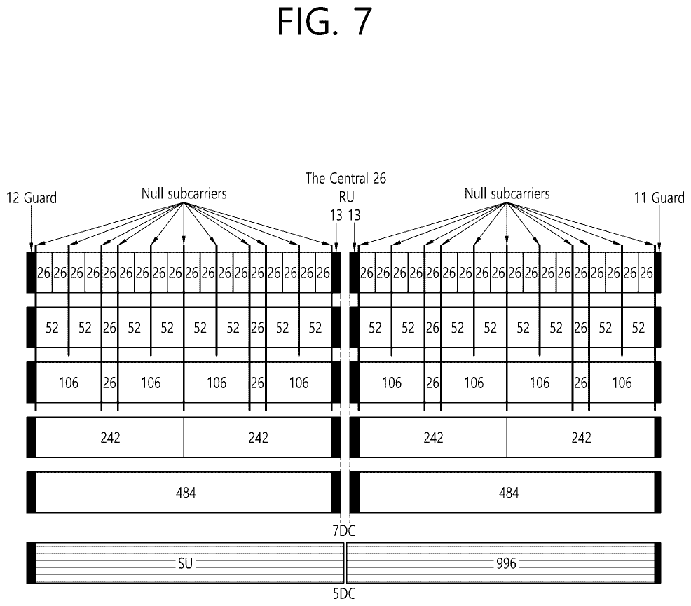

FIG. 7 illustrates a layout of RUs used in a band of 80 MHz.

Similarly to FIG. 5 and FIG. 6 in which RUs having various sizes are used, a 26-RU, a 52-RU, a 106-RU, a 242-RU, a 484-RU, a 996-RU, and the like may be used in an example of FIG. 7. Further, seven DC tones may be inserted in the center frequency, 12 tones may be used for a guard band in the leftmost band of the 80 MHz band, and 11 tones may be used for a guard band in the rightmost band of the 80 MHz band. In addition, a 26-RU corresponding to 13 tones on each of the left and right sides of the DC band may be used.

As illustrated in FIG. 7, when the layout of the RUs is used for a single user, a 996-RU may be used, in which case five DC tones may be inserted.

The RU described in the present specification may be used in uplink (UL) communication and downlink (DL) communication. For example, when UL-MU communication which is solicited by a trigger frame is performed, a transmitting STA (e.g., an AP) may allocate a first RU (e.g., 26/52/106/242-RU, etc.) to a first STA through the trigger frame, and may allocate a second RU (e.g., 26/52/106/242-RU, etc.) to a second STA. Thereafter, the first STA may transmit a first trigger-based PPDU based on the first RU, and the second STA may transmit a second trigger-based PPDU based on the second RU. The first/second trigger-based PPDU is transmitted to the AP at the same (or overlapped) time period.

For example, when a DL MU PPDU is configured, the transmitting STA (e.g., AP) may allocate the first RU (e.g., 26/52/106/242-RU. etc.) to the first STA, and may allocate the second RU (e.g., 26/52/106/242-RU, etc.) to the second STA. That is, the transmitting STA (e.g., AP) may transmit HE-STF, HE-LTF, and Data fields for the first STA through the first RU in one MU PPDU, and may transmit HE-STF, HE-LTF, and Data fields for the second STA through the second RU.

Information related to a layout of the RU may be signaled through HE-SIG-B.

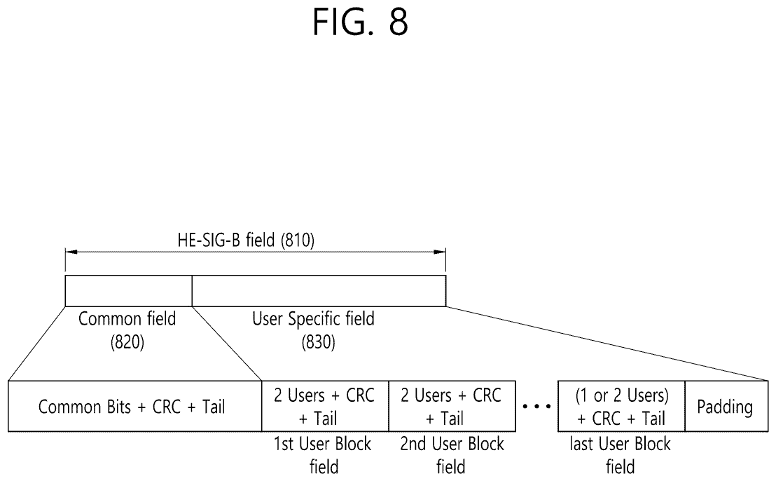

FIG. 8 illustrates a structure of an HE-SIG-B field.

As illustrated, an HE-SIG-B field 810 includes a common field 820 and a user-specific field 830. The common field 820 may include information commonly applied to all users (i.e., user STAs) which receive SIG-B. The user-specific field 830 may be called a user-specific control field. When the SIG-B is transferred to a plurality of users, the user-specific field 830 may be applied only any one of the plurality of users.

As illustrated in FIG. 8, the common field 820 and the user-specific field 830 may be separately encoded.

The common field 820 may include RU allocation information of N*8 bits. For example, the RU allocation information may include information related to a location of an RU. For example, when a 20 MHz channel is used as shown in FIG. 5, the RU allocation information may include information related to a specific frequency band to which a specific RU (26-RU/52-RU/106-RU) is arranged.

An example of a case in which the RU allocation information consists of 8 bits is as follows.

TABLE 1

| RU Allocation | | | | | | | | | | |
|---|---|---|---|---|---|---|---|---|---|---|
| subfield | | | | | | | | | | Number |
| (B7 B6 B5 B4 | | | | | | | | | | of |
| B3 B2 B1 B0) | #1 | #2 | #3 | #4 | #5 | #6 | #7 | #8 | #9 | entries |
| 00000000 | 26 | 26 | 26 | 26 | 26 | 26 | 26 | 26 | 26 | 1 |

| | | | | | | | | | |
|---|---|---|---|---|---|---|---|---|---|
| 00000001 | 26 | 26 | 26 | 26 | 26 | 26 | 26 | 52 | 1 |

| | | | | | | | | | |
|---|---|---|---|---|---|---|---|---|---|
| 00000010 | 26 | 26 | 26 | 26 | 26 | 52 | 26 | 26 | 1 |

| | | | | | | | | |
|---|---|---|---|---|---|---|---|---|
| 00000011 | 26 | 26 | 26 | 26 | 26 | 52 | 52 | 1 |

| | | | | | | | | | |
|---|---|---|---|---|---|---|---|---|---|
| 00000100 | 26 | 26 | 52 | 26 | 26 | 26 | 26 | 26 | 1 |

| | | | | | | | | |
|---|---|---|---|---|---|---|---|---|
| 00000101 | 26 | 26 | 52 | 26 | 26 | 26 | 52 | 1 |

| | | | | | | | | |
|---|---|---|---|---|---|---|---|---|
| 00000110 | 26 | 26 | 52 | 26 | 52 | 26 | 26 | 1 |

| | | | | | | | |
|---|---|---|---|---|---|---|---|
| 00000111 | 26 | 26 | 52 | 26 | 52 | 52 | 1 |

| | | | | | | | | | |
|---|---|---|---|---|---|---|---|---|---|
| 00001000 | 52 | 26 | 26 | 26 | 26 | 26 | 26 | 26 | 1 |

| | | | | | | | | |
|---|---|---|---|---|---|---|---|---|
| 00001001 | 52 | 26 | 26 | 26 | 26 | 26 | 52 | 1 |

| | | | | | | | | |
|---|---|---|---|---|---|---|---|---|
| 00001010 | 52 | 26 | 26 | 26 | 52 | 26 | 26 | 1 |

As shown the example of FIG. 5, up to nine 26-RUs may be allocated to the 20 MHz channel. When the RU allocation information of the common field 820 is set to “00000000” as shown in Table 1, the nine 26-RUs may be allocated to a corresponding channel (i.e., 20 MHz). In addition, when the RU allocation information of the common field 820 is set to “00000001” as shown in Table 1, seven 26-RUs and one 52-RU are arranged in a corresponding channel. That is, in the example of FIG. 5, the 52-RU may be allocated to the rightmost side, and the seven 26-RUs may be allocated to the left thereof.

The example of Table 1 shows only some of RU locations capable of displaying the RU allocation information.

For example, the RU allocation information may include an example of Table 2 below.

TABLE 2

| 8 bit indices | | | | | | | | | | Number |
|---|---|---|---|---|---|---|---|---|---|---|
| (B7 B6 B5 B4 | | | | | | | | | | of |
| B3 B2 B1 B0) | #1 | #2 | #3 | #4 | #5 | #6 | #7 | #8 | #9 | entries |

| | | | | | | | |
|---|---|---|---|---|---|---|---|
| 01000y2y1y0 | 106 | 26 | 26 | 26 | 26 | 26 | 8 |

| | | | | | | |
|---|---|---|---|---|---|---|
| 01001y2y1y0 | 106 | 26 | 26 | 26 | 52 | 8 |

“01000y2y1y0” relates to an example in which a 106-RU is allocated to the leftmost side of the 20 MHz channel, and five 26-RUs are allocated to the right side thereof. In this case, a plurality of STAs (e.g., user-STAs) may be allocated to the 106-RU, based on a MU-MIMO scheme. Specifically, up to 8 STAs (e.g., user-STAs) may be allocated to the 106-RU, and the number of STAs (e.g., user-STAs) allocated to the 106-RU is determined based on 3-bit information (y2y1y0). For example, when the 3-bit information (y2y1y0) is set to N, the number of STAs (e.g., user-STAs) allocated to the 106-RU based on the MU-MIMO scheme may be N+1.

In general, a plurality of STAs (e.g., user STAs) different from each other may be allocated to a plurality of RUs. However, the plurality of STAs (e.g., user STAs) may be allocated to one or more RUs having at least a specific size (e.g., 106 subcarriers), based on the MU-MIMO scheme.

As shown in FIG. 8, the user-specific field 830 may include a plurality of user fields. As described above, the number of STAs (e.g., user STAs) allocated to a specific channel may be determined based on the RU allocation information of the common field 820. For example, when the RU allocation information of the common field 820 is “00000000”, one user STA may be allocated to each of nine 26-RUs (e.g., nine user STAs may be allocated). That is, up to 9 user STAs may be allocated to a specific channel through an OFDMA scheme. In other words, up to 9 user STAs may be allocated to a specific channel through a non-MU-MIMO scheme.

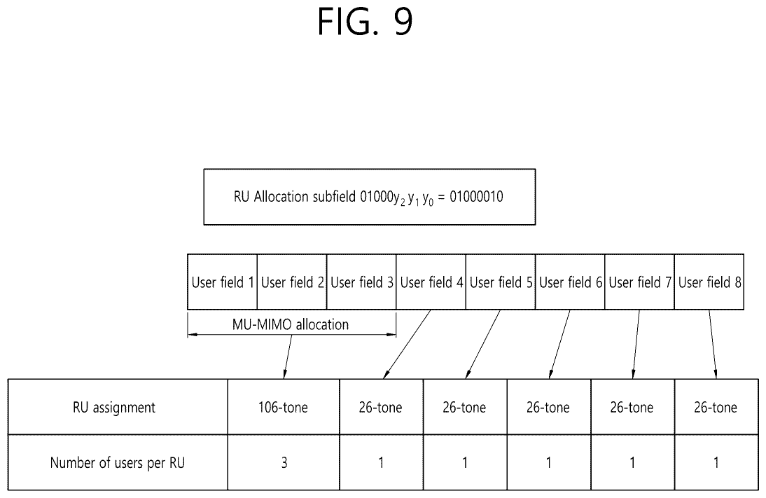

For example, when RU allocation is set to “01000y2y1y0”, a plurality of STAs may be allocated to the 106-RU arranged at the leftmost side through the MU-MIMO scheme, and five user STAs may be allocated to five 26-RUs arranged to the right side thereof through the non-MU MIMO scheme. This case is specified through an example of FIG. 9.

FIG. 9 illustrates an example in which a plurality of user STAs are allocated to the same RU through a MU-MIMO scheme.

For example, when RU allocation is set to “01000010” as shown in FIG. 9, a 106-RU may be allocated to the leftmost side of a specific channel, and five 26-RUs may be allocated to the right side thereof. In addition, three user STAs may be allocated to the 106-RU through the MU-MIMO scheme. As a result, since eight user STAs are allocated, the user-specific field 830 of HE-SIG-B may include eight user fields.

The eight user fields may be expressed in the order shown in FIG. 9. In addition, as shown in FIG. 8, two user fields may be implemented with one user block field.

The user fields shown in FIG. 8 and FIG. 9 may be configured based on two formats. That is, a user field related to a MU-MIMO scheme may be configured in a first format, and a user field related to a non-MIMO scheme may be configured in a second format. Referring to the example of FIG. 9, a user field 1 to a user field 3 may be based on the first format, and a user field 4 to a user field 8 may be based on the second format. The first format or the second format may include bit information of the same length (e.g., 21 bits).

Each user field may have the same size (e.g., 21 bits). For example, the user field of the first format (the first of the MU-MIMO scheme) may be configured as follows.

For example, a first bit (i.e., B0-B10) in the user field (i.e., 21 bits) may include identification information (e.g., STA-ID, partial AID, etc.) of a user STA to which a corresponding user field is allocated. In addition, a second bit (i.e., B11-B14) in the user field (i.e., 21 bits) may include information related to a spatial configuration.

In addition, a third bit (i.e., B15-18) in the user field (i.e., 21 bits) may include modulation and coding scheme (MCS) information. The MCS information may be applied to a data field in a PPDU including corresponding SIG-B.

An MCS, MCS information, an MCS index, an MCS field, or the like used in the present specification may be indicated by an index value. For example, the MCS information may be indicated by an index 0 to an index 11. The MCS information may include information related to a constellation modulation type (e.g., BPSK, QPSK, 16-QAM, 64-QAM, 256-QAM, 1024-QAM, etc.) and information related to a coding rate (e.g., 1/2, 2/3, 3/4, 5/6e, etc.). Information related to a channel coding type (e.g., LCC or LDPC) may be excluded in the MCS information.

In addition, a fourth bit (i.e., B19) in the user field (i.e., 21 bits) may be a reserved field.

In addition, a fifth bit (i.e., B20) in the user field (i.e., 21 bits) may include information related to a coding type (e.g., BCC or LDPC). That is, the fifth bit (i.e., B20) may include information related to a type (e.g., BCC or LDPC) of channel coding applied to the data field in the PPDU including the corresponding SIG-B.

The aforementioned example relates to the user field of the first format (the format of the MU-MIMO scheme). An example of the user field of the second format (the format of the non-MU-MIMO scheme) is as follows.

A first bit (e.g., B0-B10) in the user field of the second format may include identification information of a user STA. In addition, a second bit (e.g., B11-B13) in the user field of the second format may include information related to the number of spatial streams applied to a corresponding RU. In addition, a third bit (e.g., B14) in the user field of the second format may include information related to whether a beamforming steering matrix is applied. A fourth bit (e.g., B15-B18) in the user field of the second format may include modulation and coding scheme (MCS) information. In addition, a fifth bit (e.g., B19) in the user field of the second format may include information related to whether dual carrier modulation (DCM) is applied. In addition, a sixth bit (i.e., B20) in the user field of the second format may include information related to a coding type (e.g., BCC or LDPC).

Hereinafter, a PPDU transmitted/received in a STA of the present specification will be described.

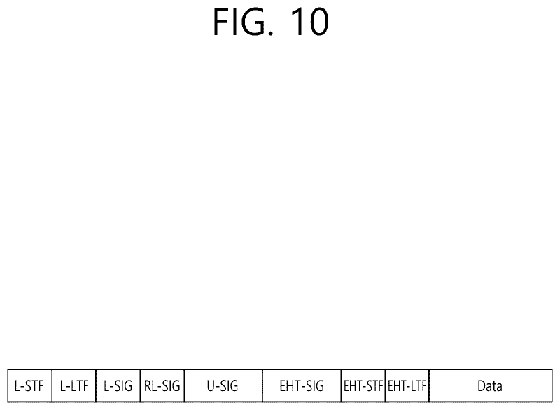

FIG. 10 illustrates an example of a PPDU used in the present specification.

The PPDU of FIG. 10 may be called in various terms such as an EHT PPDU, a TX PPDU, an RX PPDU, a first type or N-th type PPDU, or the like. For example, in the present specification, the PPDU or the EHT PPDU may be called in various terms such as a TX PPDU, a RX PPDU, a first type or N-th type PPDU, or the like. In addition, the EHT PPDU may be used in an EHT system and/or a new WLAN system enhanced from the EHT system.

The PPDU of FIG. 10 may indicate the entirety or part of a PPDU type used in the EHT system. For example, the example of FIG. 10 may be used for both of a single-user (SU) mode and a multi-user (MU) mode. In other words, the PPDU of FIG. 10 may be a PPDU for one receiving STA or a plurality of receiving STAs. When the PPDU of FIG. 10 is used for a trigger-based (TB) mode, the EHT-SIG of FIG. 10 may be omitted. In other words, an STA which has received a trigger frame for uplink-MU (UL-MU) may transmit the PPDU in which the EHT-SIG is omitted in the example of FIG. 10.

In FIG. 10, an L-STF to an EHT-LTF may be called a preamble or a physical preamble, and may be generated/transmitted/received/obtained/decoded in a physical layer.

A subcarrier spacing of the L-STF, L-LTF, L-SIG, RL-SIG, U-SIG, and EHT-SIG fields of FIG. 10 may be determined as 312.5 kHz, and a subcarrier spacing of the EHT-STF, EHT-LTF, and Data fields may be determined as 78.125 kHz. That is, a tone index (or subcarrier index) of the L-STF, L-LTF, L-SIG, RL-SIG, U-SIG, and EHT-SIG fields may be expressed in unit of 312.5 kHz, and a tone index (or subcarrier index) of the EHT-STF, EHT-LTF, and Data fields may be expressed in unit of 78.125 kHz.

In the PPDU of FIG. 10, the L-LTE and the L-STF may be the same as those in the conventional fields.

The L-SIG field of FIG. 10 may include, for example, bit information of 24 bits. For example, the 24-bit information may include a rate field of 4 bits, a reserved bit of 1 bit, a length field of 12 bits, a parity bit of 1 bit, and a tail bit of 6 bits. For example, the length field of 12 bits may include information related to a length or time duration of a PPDU. For example, the length field of 12 bits may be determined based on a type of the PPDU. For example, when the PPDU is a non-HT, HT, VHT PPDU or an EHT PPDU, a value of the length field may be determined as a multiple of 3. For example, when the PPDU is an HE PPDU, the value of the length field may be determined as “a multiple of 3”+1 or “a multiple of 3”+2. In other words, for the non-HT, HT, VHT PPDI or the EHT PPDU, the value of the length field may be determined as a multiple of 3, and for the HE PPDU, the value of the length field may be determined as “a multiple of 3”+1 or “a multiple of 3”+2.

For example, the transmitting STA may apply BCC encoding based on a 1/2 coding rate to the 24-bit information of the L-SIG field. Thereafter, the transmitting STA may obtain a BCC coding bit of 48 bits. BPSK modulation may be applied to the 48-bit coding bit, thereby generating 48 BPSK symbols. The transmitting STA may map the 48 BPSK symbols to positions except for a pilot subcarrier{subcarrier index −21, −7, +7, +21} and a DC subcarrier{subcarrier index 0}. As a result, the 48 BPSK symbols may be mapped to subcarrier indices −26 to −22, −20 to −8, −6 to −1, +1 to +6, +8 to +20, and +22 to +26. The transmitting STA may additionally map a signal of {−1, −1, −1, 1} to a subcarrier index{−28, −27, +27, +28}. The aforementioned signal may be used for channel estimation on a frequency domain corresponding to {−28, −27, +27, +28}.

The transmitting STA may generate an RL-SIG generated in the same manner as the L-SIG. BPSK modulation may be applied to the RL-SIG. The receiving STA may know that the RX PPDU is the HE PPDU or the EHT PPDU, based on the presence of the RL-SIG.

A universal SIG (U-SIG) may be inserted after the RL-SIG of FIG. 10. The U-SIB may be called in various terms such as a first SIG field, a first SIG, a first type SIG, a control signal, a control signal field, a first (type) control signal, or the like.

The U-SIG may include information of N bits, and may include information for identifying a type of the EHT PPDU. For example, the U-SIG may be configured based on two symbols (e.g., two contiguous OFDM symbols). Each symbol (e.g., OFDM symbol) for the U-SIG may have a duration of 4 μs. Each symbol of the U-SIG may be used to transmit the 26-bit information. For example, each symbol of the U-SIG may be transmitted/received based on 52 data tomes and 4 pilot tones.

Through the U-SIG (or U-SIG field), for example, A-bit information (e.g., 52 un-coded bits) may be transmitted. A first symbol of the U-SIG may transmit first X-bit information (e.g., 26 un-coded bits) of the A-bit information, and a second symbol of the U-SIB may transmit the remaining Y-bit information (e.g. 26 un-coded bits) of the A-bit information. For example, the transmitting STA may obtain 26 un-coded bits included in each U-SIG symbol. The transmitting STA may perform convolutional encoding (i.e., BCC encoding) based on a rate of R=1/2 to generate 52-coded bits, and may perform interleaving on the 52-coded bits. The transmitting STA may perform BPSK modulation on the interleaved 52-coded bits to generate 52 BPSK symbols to be allocated to each U-SIG symbol. One U-SIG symbol may be transmitted based on 65 tones (subcarriers) from a subcarrier index −28 to a subcarrier index +28, except for a DC index 0. The 52 BPSK symbols generated by the transmitting STA may be transmitted based on the remaining tones (subcarriers) except for pilot tones, i.e., tones −21, −7, +7, +21.

For example, the A-bit information (e.g., 52 un-coded bits) generated by the U-SIG may include a CRC field (e.g., a field having a length of 4 bits) and a tail field (e.g., a field having a length of 6 bits). The CRC field and the tail field may be transmitted through the second symbol of the U-SIG. The CRC field may be generated based on 26 bits allocated to the first symbol of the U-SIG and the remaining 16 bits except for the CRC/tail fields in the second symbol, and may be generated based on the conventional CRC calculation algorithm. In addition, the tail field may be used to terminate trellis of a convolutional decoder, and may be set to, for example, “000000”.

The A-bit information (e.g., 52 un-coded bits) transmitted by the U-SIG (or U-SIG field) may be divided into version-independent bits and version-dependent bits. For example, the version-independent bits may have a fixed or variable size. For example, the version-independent bits may be allocated only to the first symbol of the U-SIG, or the version-independent bits may be allocated to both of the first and second symbols of the U-SIG. For example, the version-independent bits and the version-dependent bits may be called in various terms such as a first control bit, a second control bit, or the like.

For example, the version-independent bits of the U-SIG may include a PHY version identifier of 3 bits. For example, the PHY version identifier of 3 bits may include information related to a PHY version of a TX/RX PPDU. For example, a first value of the PHY version identifier of 3 bits may indicate that the TX/RX PPDU is an EHT PPDU. In other words, when the transmitting STA transmits the EHT PPDU, the PHY version identifier of 3 bits may be set to a first value. In other words, the receiving STA may determine that the RX PPDU is the EHT PPDU, based on the PHY version identifier having the first value.

For example, the version-independent bits of the U-SIG may include a UL/DL flag field of 1 bit. A first value of the UL/DL flag field of 1 bit relates to UL communication, and a second value of the UL/DL flag field relates to DL communication.

For example, the version-independent bits of the U-SIG may include information related to a TXOP length and information related to a BSS color ID.

For example, when the EHT PPDU is divided into various types (e.g., various types such as an EHT PPDU related to an SU mode, an EHT PPDU related to a MU mode, an EHT PPDU related to a TB mode, an EHT PPDU related to extended range transmission, or the like), information related to the type of the EHT PPDU may be included in the version-dependent bits of the U-SIG.

For example, the U-SIG may include: 1) a bandwidth field including information related to a bandwidth; 2) a field including information related to an MCS scheme applied to EHT-SIG; 3) an indication field including information regarding whether a dual subcarrier modulation (DCM) scheme is applied to EHT-SIG; 4) a field including information related to the number of symbol used for EHT-SIG; 5) a field including information regarding whether the EHT-SIG is generated across a full band; 6) a field including information related to a type of EHT-LTF/STF; and 7) information related to a field indicating an EHT-LTF length and a CP length.

Preamble puncturing may be applied to the PPDU of FIG. 10. The preamble puncturing implies that puncturing is applied to part (e.g., a secondary 20 MHz band) of the full band. For example, when an 80 MHz PPDU is transmitted, an STA may apply puncturing to the secondary 20 MHz band out of the 80 MHz band, and may transmit a PPDU only through a primary 20 MHz band and a secondary 40 MHz band.

For example, a pattern of the preamble puncturing may be configured in advance. For example, when a first puncturing pattern is applied, puncturing may be applied only to the secondary 20 MHz band within the 80 MHz band. For example, when a second puncturing pattern is applied, puncturing may be applied to only any one of two secondary 20 MHz bands included in the secondary 40 MHz band within the 80 MHz band. For example, when a third puncturing pattern is applied, puncturing may be applied to only the secondary 20 MHz band included in the primary 80 MHz band within the 160 MHz band (or 80+80 MHz band). For example, when a fourth puncturing is applied, puncturing may be applied to at least one 20 MHz channel not belonging to a primary 40 MHz band in the presence of the primary 40 MHz band included in the 80MHaz band within the 160 MHz band (or 80+80 MHz band).

Information related to the preamble puncturing applied to the PPDU may be included in U-SIG and/or EHT-SIG. For example, a first field of the U-SIG may include information related to a contiguous bandwidth, and second field of the U-SIG may include information related to the preamble puncturing applied to the PPDU.

For example, the U-SIG and the EHT-SIG may include the information related to the preamble puncturing, based on the following method. When a bandwidth of the PPDU exceeds 80 MHz, the U-SIG may be configured individually in unit of 80 MHz. For example, when the bandwidth of the PPDU is 160 MHz, the PPDU may include a first U-SIG for a first 80 MHz band and a second U-SIG for a second 80 MHz band. In this case, a first field of the first U-SIG may include information related to a 160 MHz bandwidth, and a second field of the first U-SIG may include information related to a preamble puncturing (i.e., information related to a preamble puncturing pattern) applied to the first 80 MHz band. In addition, a first field of the second U-SIG may include information related to a 160 MHz bandwidth, and a second field of the second U-SIG may include information related to a preamble puncturing (i.e., information related to a preamble puncturing pattern) applied to the second 80 MHz band. Meanwhile, an EHT-SIG contiguous to the first U-SIG may include information related to a preamble puncturing applied to the second 80 MHz band (i.e., information related to a preamble puncturing pattern), and an EHT-SIG contiguous to the second U-SIG may include information related to a preamble puncturing (i.e., information related to a preamble puncturing pattern) applied to the first 80 MHz band.

Additionally or alternatively, the U-SIG and the EHT-SIG may include the information related to the preamble puncturing, based on the following method. The U-SIG may include information related to a preamble puncturing (i.e., information related to a preamble puncturing pattern) for all bands. That is, the EHT-SIG may not include the information related to the preamble puncturing, and only the U-SIG may include the information related to the preamble puncturing (i.e., the information related to the preamble puncturing pattern).

The U-SIG may be configured in unit of 20 MHz. For example, when an 80 MHz PPDU is configured, the U-SIG may be duplicated. That is, four identical U-SIGs may be included in the 80 MHz PPDU. PPDUs exceeding an 80 MHz bandwidth may include different U-SIGs.

The EHT-SIG of FIG. 10 may include control information for the receiving STA. The EHT-SIG may be transmitted through at least one symbol, and one symbol may have a length of 4 μs. Information related to the number of symbols used for the EHT-SIG may be included in the U-SIG.

The EHT-SIG may include a technical feature of the HE-SIG-B described with reference to FIG. 8 and FIG. 9. For example, the EHT-SIG may include a common field and a user-specific field as in the example of FIG. 8. The common field of the EHT-SIG may be omitted, and the number of user-specific fields may be determined based on the number of users.

As in the example of FIG. 8, the common field of the EHT-SIG and the user-specific field of the EHT-SIG may be individually coded. One user block field included in the user-specific field may include information for two users, but a last user block field included in the user-specific field may include information for one user. That is, one user block field of the EHT-SIG may include up to two user fields. As in the example of FIG. 9, each user field may be related to MU-MIMO allocation, or may be related to non-MU-MIMO allocation.

As in the example of FIG. 8, the common field of the EHT-SIG may include a CRC bit and a tail bit. A length of the CRC bit may be determined as 4 bits. A length of the tail bit may be determined as 6 bits, and may be set to ‘000000’.

As in the example of FIG. 8, the common field of the EHT-SIG may include RU allocation information. The RU allocation information may imply information related to a location of an RU to which a plurality of users (i.e., a plurality of receiving STAs) are allocated. The RU allocation information may be configured in unit of 8 bits (or N bits), as in Table 1.

A mode in which the common field of the EHT-SIG is omitted may be supported. The mode in the common field of the EHT-SIG is omitted may be called a compressed mode. When the compressed mode is used, a plurality of users (i.e., a plurality of receiving STAs) may decode the PPDU (e.g., the data field of the PPDU), based on non-OFDMA. That is, the plurality of users of the EHT PPDU may decode the PPDU (e.g., the data field of the PPDU) received through the same frequency band. Meanwhile, when a non-compressed mode is used, the plurality of users of the EHT PPDU may decode the PPDU (e.g., the data field of the PPDU), based on OFDMA. That is, the plurality of users of the EHT PPDU may receive the PPDU (e.g., the data field of the PPDU) through different frequency bands.

The EHT-SIG may be configured based on various MCS schemes. As described above, information related to an MCS scheme applied to the EHT-SIG may be included in U-SIG. The EHT-SIG may be configured based on a DCM scheme. For example, among N data tones (e.g., 52 data tones) allocated for the EHT-SIG, a first modulation scheme may be applied to half of consecutive tones, and a second modulation scheme may be applied to the remaining half of the consecutive tones. That is, a transmitting STA may use the first modulation scheme to modulate specific control information through a first symbol and allocate it to half of the consecutive tones, and may use the second modulation scheme to modulate the same control information by using a second symbol and allocate it to the remaining half of the consecutive tones. As described above, information (e.g., a 1-bit field) regarding whether the DCM scheme is applied to the EHT-SIG may be included in the U-SIG. The EHT-STF of FIG. 10 may be used for improving automatic gain control estimation in a multiple input multiple output (MIMO) environment or an OFDMA environment. The EHT-LTF of FIG. 10 may be used for estimating a channel in the MIMO environment or the OFDMA environment.

Information related to a type of STF and/or LTF (information related to a GI applied to LTF is also included) may be included in a SIG-A field and/or SIG-B field or the like of FIG. 10.

A PPDU (e.g., EHT-PPDU) of FIG. 10 may be configured based on the example of FIG. 5 and FIG. 6.

For example, an EHT PPDU transmitted on a 20 MHz band, i.e., a 20 MHz EHT PPDU, may be configured based on the RU of FIG. 5. That is, a location of an RU of EHT-STF, EHT-LTF, and data fields included in the EHT PPDU may be determined as shown in FIG. 5.

An EHT PPDU transmitted on a 40 MHz band, i.e., a 40 MHz EHT PPDU, may be configured based on the RU of FIG. 6. That is, a location of an RU of EHT-STF, EHT-LTF, and data fields included in the EHT PPDU may be determined as shown in FIG. 6.

Since the RU location of FIG. 6 corresponds to 40 MHz, a tone-plan for 80 MHz may be determined when the pattern of FIG. 6 is repeated twice. That is, an 80 MHz EHT PPDU may be transmitted based on a new tone-plan in which not the RU of FIG. 7 but the RU of FIG. 6 is repeated twice.

When the pattern of FIG. 6 is repeated twice, 23 tones (i.e., 11 guard tones+12 guard tones) may be configured in a DC region. That is, a tone-plan for an 80 MHz EHT PPDU allocated based on OFDMA may have 23 DC tones. Unlike this, an 80 MHz EHT PPDU allocated based on non-OFDMA (i.e., a non-OFDMA full bandwidth 80 MHz PPDU) may be configured based on a 996-RU, and may include 5 DC tones, 12 left guard tones, and 11 right guard tones.

A tone-plan for 160/240/320 MHz may be configured in such a manner that the pattern of FIG. 6 is repeated several times.

The PPDU of FIG. 10 may be determined (or identified) as an EHT PPDU based on the following method.

A receiving STA may determine a type of an RX PPDU as the EHT PPDU, based on the following aspect. For example, the RX PPDU may be determined as the EHT PPDU: 1) when a first symbol after an L-LTF signal of the RX PPDU is a BPSK symbol; 2) when RL-SIG in which the L-SIG of the RX PPDU is repeated is detected; and 3) when a result of applying “modulo 3” to a value of a length field of the L-SIG of the RX PPDU is detected as “0”. When the RX PPDU is determined as the EHT PPDU, the receiving STA may detect a type of the EHT PPDU (e.g., an SU/MU/Trigger-based/Extended Range type), based on bit information included in a symbol after the RL-SIG of FIG. 10. In other words, the receiving STA may determine the RX PPDU as the EHT PPDU, based on: 1) a first symbol after an L-LTF signal, which is a BPSK symbol; 2) RL-SIG contiguous to the L-SIG field and identical to L-SIG; 3) L-SIG including a length field in which a result of applying “modulo 3” is set to “0”; and 4) a 3-bit PHY version identifier of the aforementioned U-SIG (e.g., a PHY version identifier having a first value).

For example, the receiving STA may determine the type of the RX PPDU as the EHT PPDU, based on the following aspect. For example, the RX PPDU may be determined as the HE PPDU: 1) when a first symbol after an L-LTF signal is a BPSK symbol; 2) when RL-SIG in which the L-SIG is repeated is detected; and 3) when a result of applying “modulo 3” to a value of a length field of the L-SIG is detected as “1” or “2”.

For example, the receiving STA may determine the type of the RX PPDU as a non-HT, HT, and VHT PPDU, based on the following aspect. For example, the RX PPDU may be determined as the non-HT, HT, and VHT PPDU: 1) when a first symbol after an L-LTF signal is a BPSK symbol; and 2) when RL-SIG in which L-SIG is repeated is not detected. In addition, even if the receiving STA detects that the RL-SIG is repeated, when a result of applying “modulo 3” to the length value of the L-SIG is detected as “0”, the RX PPDU may be determined as the non-HT, HT, and VHT PPDU.

In the following example, a signal represented as a (TX/RX/UL/DL) signal, a (TX/RX/UL/DL) frame, a (TX/RX/UL/DL) packet, a (TX/RX/UL/DL) data unit, (TX/RX/UL/DL) data, or the like may be a signal transmitted/received based on the PPDU of FIG. 10. The PPDU of FIG. 10 may be used to transmit/receive frames of various types. For example, the PPDU of FIG. 10 may be used for a control frame. An example of the control frame may include a request to send (RTS), a clear to send (CTS), a power save-poll (PS-poll), BlockACKReq, BlockAck, a null data packet (NDP) announcement, and a trigger frame. For example, the PPDU of FIG. 10 may be used for a management frame. An example of the management frame may include a beacon frame, a (re-)association request frame, a (re-)association response frame, a probe request frame, and a probe response frame. For example, the PPDU of FIG. 10 may be used for a data frame. For example, the PPDU of FIG. 10 may be used to simultaneously transmit at least two or more of the control frames, the management frame, and the data frame.

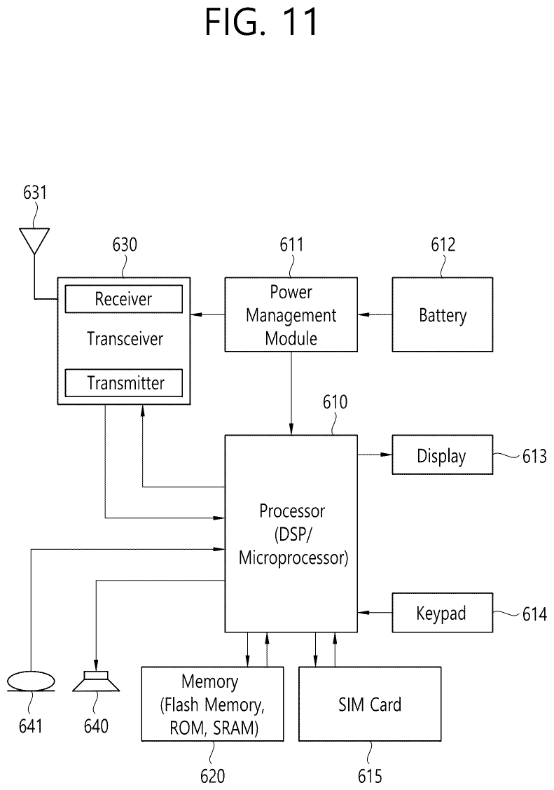

FIG. 11 illustrates an example of a modified transmission device and/or receiving device of the present specification.

Each device/STA of the sub-figure (a)/(b) of FIG. 1 may be modified as shown in FIG. 11. A transceiver 630 of FIG. 11 may be identical to the transceivers 113 and 123 of FIG. 1. The transceiver 630 of FIG. 11 may include a receiver and a transmitter.

A processor 610 of FIG. 11 may be identical to the processors 111 and 121 of FIG. 1. Alternatively, the processor 610 of FIG. 11 may be identical to the processing chips 114 and 124 of FIG. 1.

A memory 620 of FIG. 11 may be identical to the memories 112 and 122 of FIG. 1. Alternatively, the memory 620 of FIG. 11 may be a separate external memory different from the memories 112 and 122 of FIG. 1.

Referring to FIG. 11, a power management module 611 manages power for the processor 610 and/or the transceiver 630. A battery 612 supplies power to the power management module 611. A display 613 outputs a result processed by the processor 610. A keypad 614 receives inputs to be used by the processor 610. The keypad 614 may be displayed on the display 613. A SIM card 615 may be an integrated circuit which is used to securely store an international mobile subscriber identity (IMSI) and its related key, which are used to identify and authenticate subscribers on mobile telephony devices such as mobile phones and computers.

Referring to FIG. 11, a speaker 640 may output a result related to a sound processed by the processor 610. A microphone 641 may receive an input related to a sound to be used by the processor 610.

### 1. Channelization of a 6 GHz Band (Definition of a 480 MHz Channel and a 640 MHz Channels)

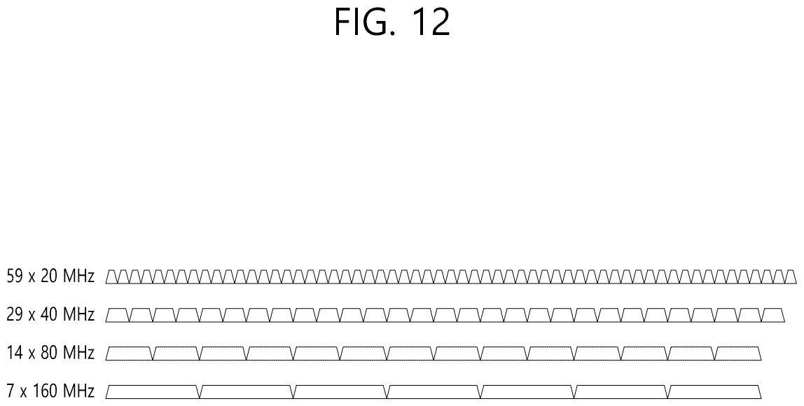

FIGS. 12 to 14 show channels from 20 MHz to 160 MHz currently used in 802.11be.

FIG. 12 shows the channelization of the 6 GHz band.

Referring to FIG. 12, the 6 GHz band has a total spectrum of 1200 MHz, and the total spectrum may include 59 20 MHz channels, 29 40 MHz channels, 14 80 MHz channels, or 7 160 MHz channels.

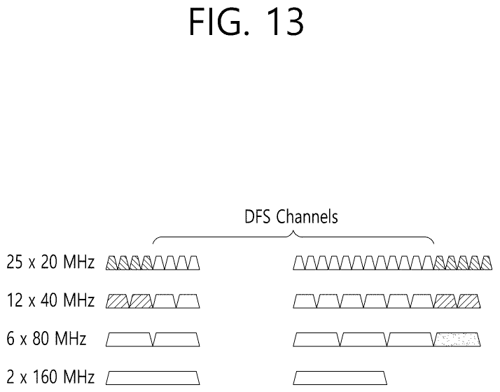

FIG. 13 shows the channelization of the 5 GHz band.

Referring to FIG. 13, the 5 GHz band has a total spectrum of 500 MHz (180 MHz without DFS (Dynamic Frequency Selection)), and the total spectrum may include 25 20 MHz channels, 12 40 MHz channels, 6 80 MHz channels, or 2 160 MHz channels.

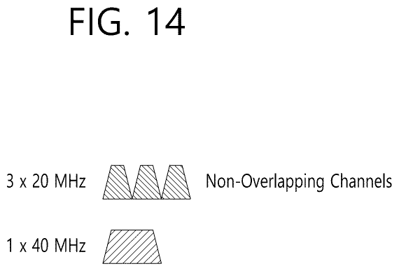

FIG. 14 shows the channelization of the 2.4 GHz band.

Referring to FIG. 14, the 2.4 GHz band has a total spectrum of 80 MHz, and the total spectrum may include three 20 MHz channels (non-overlapping channels) or one 40 MHz channel.

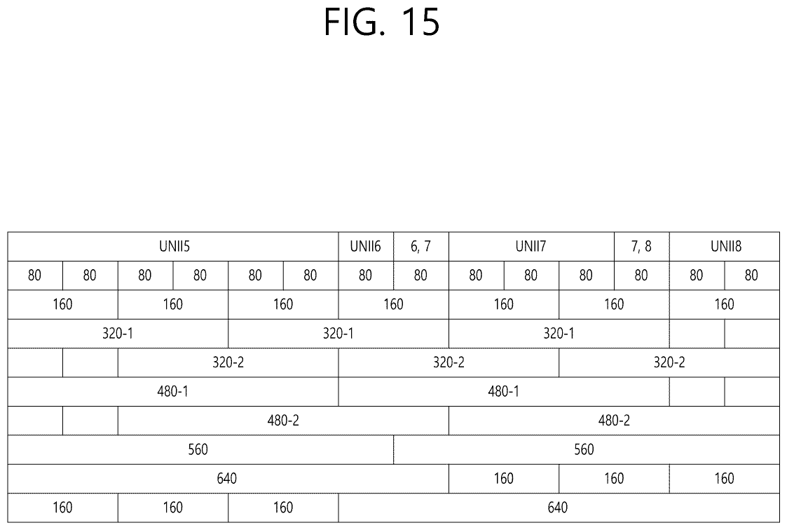

FIG. 15 shows channelization and extended channelization of the 6 GHz band of the 802.11be wireless LAN system.

Referring to FIG. 15, a 320 MHz channel is generated by combining two 160 MHz channels, and two types of 320 MHz channels (320-1 MHz channel and 320-2 MHz channel) overlap each other. In other words, a 320 MHz channel was defined to maximize utilization within the total spectrum of the 6 GHz band by partially overlapping 320 channels.

EHT (802.11be) supports not only the 160 MHz BW (BandWidth) that was supported up to 802.11ax, but also a wider BW (BandWidth) of 320 MHz. In the existing 20/40/80/160 MHz channelization, overlapping channels did not exist. However, 320 MHz BW includes overlapping channels such as 320-1 MHz and 320-2 MHz in FIG. 15. Overlapping channels may or may not exist between the 320-1 MHz channel and the 320-2 MHz channel. for example, in FIG. 15, the first 320-1 MHz channel and the first 320-2 MHz channel have overlapping channels of 160 MHz BW, but the first 320-1 MHz channel and the second 320-2 MHz channel do not have overlapping channels. Meanwhile, currently, the 320-1 MHz channel and the 320-2 MHz channel are signaled separately in the BW subfield of the Universal Signal (U-SIG) field of the EHT PPDU. The 320-1 MHz channel and 320-2 MHz channel are channels supported by different BSS (Basic Service Set). For example, the first BSS may support a 320-1 MHz channel, and the second BSS may support a 320-2 MHz channel.

The reason for distinguishing between 320-1 MHz and 320-2 MHz is because if the STA's primary 20 MHz channel is in an area where 320-1 MHz and 320-2 MHz overlap, it must be distinguished whether it is allocated to 320-1 MHz or 320-2 MHz.

In this specification, the 160 MHz channel including the primary channel (i.e., 20 MHz primary channel) is referred to as P160, and the 160 MHz channel without it is referred to as S160.

Additionally, this specification proposes to include a 480 MHz channel and a 640 MHz channel, which are extended channels within the 6 GHz band. Descriptions of the 480 MHz channel and 640 MHz channel will be provided later.

The table below shows the configuration of the U-SIG Version Independent field in the EHT MU PPDU of FIG. 10. The Version Independent field can be used in the format below even in Wi-Fi after 802.11be.

TABLE 3

| Two parts | | | Number | |
|---|---|---|---|---|
| of U-SIG | Bit | Field | of bits | Description |
| U-SIG-1 | B0-B2 | PHY Version Identifier | 3 | Differentiate between different PHY clauses. |
| | | | | Set to 0 for EHT. |
| | | | | Values 1-7 are Validate. |
| | B3-B5 | Bandwidth | 3 | Sct to 0 for 20 MHz. |
| | | | | Set to 1 for 40 MHz. |
| | | | | Set to 2 for 80 MHz. |
| | | | | Set to 3 for 160 MHz. |
| | | | | Set to 4 for 320 MHz-1. |
| | | | | Set to 5 for 320 MHz-2. |
| | | | | Values 6 and 7 are Validate. |
| | B6 | UL/DL | 1 | Indicates whether the PPDU is sent in UL or |
| | | | | DL. Set to the TXVECTOR parameter |
| | | | | UPLINK_FLAG. |
| | | | | A value of 1 indicates the PPDU is |
| | | | | addressed to an AP. |
| | | | | A value of 0 indicates the PPDU is |
| | | | | addressed to a non-AP STA. |
| | B7-B12 | BSS Color | 6 | An identifier of the BSS. |
| | | | | Set to the TXVECTOR parameter |
| | | | | BSS_COLOR. |
| | B13-B19 | TXOP | 7 | If the TXVECTOR parameter |
| | | | | TXOP_DURATION is UNSPECIFIED, set to |
| | | | | 127 to indicate the absence of duration |
| | | | | information. |
| | | | | If the TXVECTOR parameter |
| | | | | TXOP_DURATION is an integer value, set to |
| | | | | a value less than 127 to indicate duration |
| | | | | information for NAV setting and protection of |
| | | | | the TXOP as follows: |
| | | | | If the TXVECTOR parameter |
| | | | | TXOP_DURATION is less than 512, set to |
| | | | | 2 × floor(TXOP_DURATION/8). |
| | | | | Otherwise, set to |
| | | | | 2 × floor((TXOP_DURATION − 512)/ |
| | | | | 128) + 1. |
| | B20-B24 | Disregard | 5 | Set to all 1s and treat as Disregard. |
| | B25 | Validate | 1 | Set to 1 and treat as Validate. |
| U-SIG-2 | B0-B1 | PPDU Type And | 2 | If the UL/DL field is set to 0: |
| | | Compression Mode | | A value of 0 indicates a DL OFDMA |
| | | | | transmission. |
| | | | | A value of 1 indicates a transmission to a |
| | | | | single user or an EHT sounding NDP. |
| | | | | A value of 2 indicates a non-OFDMA DL |
| | | | | MU-MIMO transmission. |
| | | | | A value of 3 is Validate. |
| | | | | If the UL/DL field is set to 1: |
| | | | | A value of 1 indicates a transmission to a |
| | | | | single user or an EHT sounding NDP. |
| | | | | Values 2 and 3 are Validate. |
| | | | | NOTE—A value of 0 indicates a TB |
| | | | | PPDU. |
| | | | | For further clarifications on all values of |
| | | | | this field, refer to Table 9 (Combination of |
| | | | | UL/DL and PPDU Type And Compression |
| | | | | Mode field). |
| | B2 | Validate | 1 | Set to 1 and treat as Validate. |
| | B3-B7 | Punctured Channel | 5 | If the PPDU Type And Compression Mode |
| | | Information | | field is set to 1 regardless of the value of the |
| | | | | UL/DL field, or the PPDU Type And |
| | | | | Compression Mode field is set to 2 and the |
| | | | | UL/DL field is 0: |
| | | | | Indicates the puncturing information of |
| | | | | this non-OFDMA transmission. See |
| | | | | Table 10 (Definition of the Punctured |
| | | | | Channel Information field in the U-SIG |
| | | | | for an EHT MU PPDU using non- |
| | | | | OFDMA transmissions) for the |
| | | | | definition. Undefined values of this field |
| | | | | are Validate. |
| | | | | If the PPDU Type And Compression Mode |
| | | | | field is set to 0 and the UL/DL field is 0: |
| | | | | If the Bandwidth field is set to a value |
| | | | | between 2 and 5, which indicates an |
| | | | | 80 MHz, 160 MHz or 320 MHz PPDU, |
| | | | | then B3-B6 is a 4-bit bitmap that |
| | | | | indicates which 20 MHz subchannel is |
| | | | | punctured in the 80 MHz frequency |
| | | | | subblock where U-SIG processing is |
| | | | | performed. The 4-bit bitmap is indexed |
| | | | | by the 20 MHz subchannels in ascending |
| | | | | order with B3 indicating the lowest |
| | | | | frequency 20 MHz subchannel. For each |
| | | | | of the bits B3-B6, a value of 0 indicates |
| | | | | that the corresponding 20 MHz channel |
| | | | | is punctured, and a value of 1 is used |
| | | | | otherwise. The following allowed |
| | | | | punctured patterns (B3-B6) are defined |
| | | | | for an 80 MHz frequency subblock: 1111 |
| | | | | (no puncturing), 0111, 1011, 1101, 1110, |
| | | | | 0011, 1100, and 1001. Any field values |
| | | | | other than the allowed punctured patterns |
| | | | | are Validate. Field value may be varied. |
| | | | | from one 80 MHz to the other. |
| | | | | If the Bandwidth field is set to 0 or 1, |
| | | | | which indicates a 20/40 MHz PPDU, |
| | | | | B3-B6 are set to all 1s. Other values are |
| | | | | Validate. |
| | | | | B7 is set to 1 and Disregard. |
| | B8 | Validate | 1 | Set to 1 and treat as Validate. |
| | B9-B10 | EHT-SIG MCS | 2 | Indicates the MCS used for modulating the |
| | | | | EHT-SIG. |
| | | | | Set to 0 for EIIT-MCS 0. |
| | | | | Set to 1 for EHT-MCS 1. |
| | | | | Set to 2 for EHT-MCS 3. |
| | | | | Set to 3 for EHT-MCS 15. |
| | B11-B15 | Number Of EHT-SIG | 5 | Indicates the number of EHT-SIG symbols. |
| | | Symbols | | Set to a value that is the number of EHT-SIG |
| | | | | symbols minus 1. This value shall be the same |
| | | | | in every 80 MHz frequency subblock. |
| | B16-B19 | CRC | 4 | CRC for bits 0-41 of the U-SIG field. Bits |
| | | | | 0-41 of the U-SIG field correspond to bits |
| | | | | 0-25 of U-SIG-1 field followed by bits 0-15 |
| | | | | of U-SIG-2 field. |
| | B20-B25 | Tail | 6 | Used to terminate the trellis of the |
| | | | | convolutional decoder. Set to 0. |

In Wi-Fi after 802.11be, PHY Version Identifier can be set to a value other than 0. Additionally, when a bandwidth and channel wider than 320 MHz can be defined and PPDU is transmitted using that bandwidth, it can be indicated using the Validate value (i.e., 6 and 7) of the BW field in Table 3 above, or can be indicated by using an additional 1 bit in the BW field.

### 2. HE/EHT Operation Element Definition

### 2.1 HE Operation Element

In a High Efficiency (HE) BSS, the operation of HE STAs is controlled by the following.
High Throughput (HT) Operation element and HE Operation element when operating in the 2.4 GHz band
HE Operation element, Very High Throughput (VHT) Operation element (if present), and HE Operation element when operating in the 5 GHz band
HE Operation element when operating in the 6 GHz band (operation in the 6 GHz band is first defined in 802.11ax)

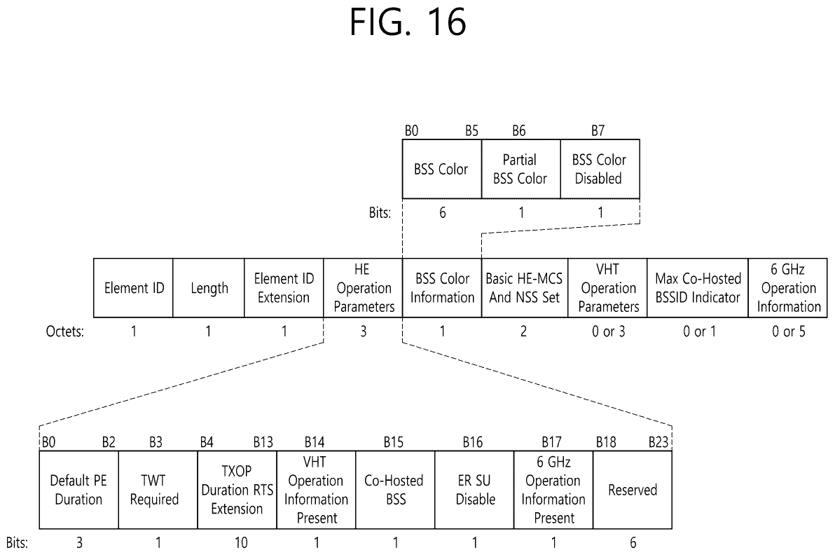

FIG. 16 shows the format of the HE Operation element.

The HE Operation element may include a HE Operation Parameters field, a BSS Color Information field, and a 6 GHz Operation Information field, etc.

The HE Operation Parameters field includes a Default PE Duration subfield, a TWT Required subfield, a TXOP Duration RTS Threshold subfield, a VHT Operation Information Present subfield, a Co-Hosted BSS subfield, an ER SU Disable subfield, and a 6 GHz Operation Information Present subfield, etc.

The Default PE Duration subfield, along with the TRS Control subfield, indicates a Packet Extension (PE) field duration in 4us units for the requested HE Trigger Based (TB) PPDU. Values 5-7 of the Default PE Duration subfield are reserved.

When the 6 GHz Operation Information Present subfield is set to 1, the 6 GHz Operation Information field exists, and when the 6 GHz Operation Information Present subfield is set to 0, the 6 GHz Operation Information field does not exist. The 6 GHz Operation Information Present subfield is set to 1 by the AP operating in the 6 GHz band.

The BSS Color Information field includes a BSS Color subfield, Partial BSS Color subfield, and BSS Color Disabled subfield.

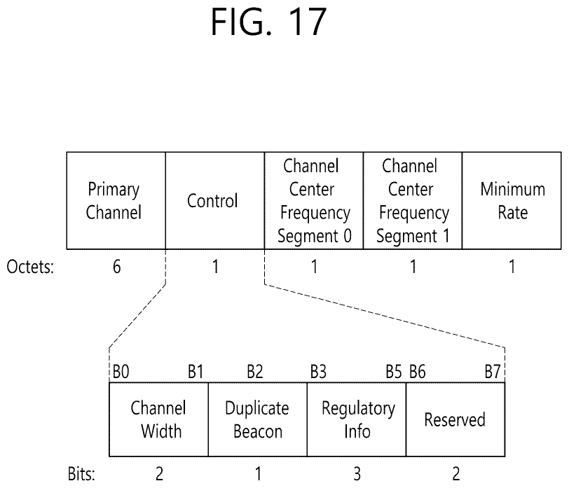

FIG. 17 shows the format of the 6 GHz Operation Information field.

The 6 GHz Operation Information field includes a Primary Channel field, Control field, Channel Center Frequency Segment 0/1 field, and Minimum Rate field, etc.

The Primary Channel field indicates the number of primary channels in the 6 GHz band.

The Control field includes a Channel Width subfield, Duplicate Beacon subfield, and Regulatory Info subfield.

The Channel Width subfield indicates the BSS channel width and is set to 0 for 20 MHz, 1 for 40 MHz, 2 for 80 MHz, and 3 for 80+80 or 160 MHz.

### 2.2 EHT Operation Element

The operation of EHT STAs in the EHT BSS is controlled by:
When operating in the 2.4 GHz band, HT Operation element, HE Operation element, and EHT Operation element
When operating in the 5 GHz band, HE Operation element, VHT Operation element (if present), HE Operation element, and EHT Operation element
HE Operation element and EHT Operation element when operating in the 6 GHz band

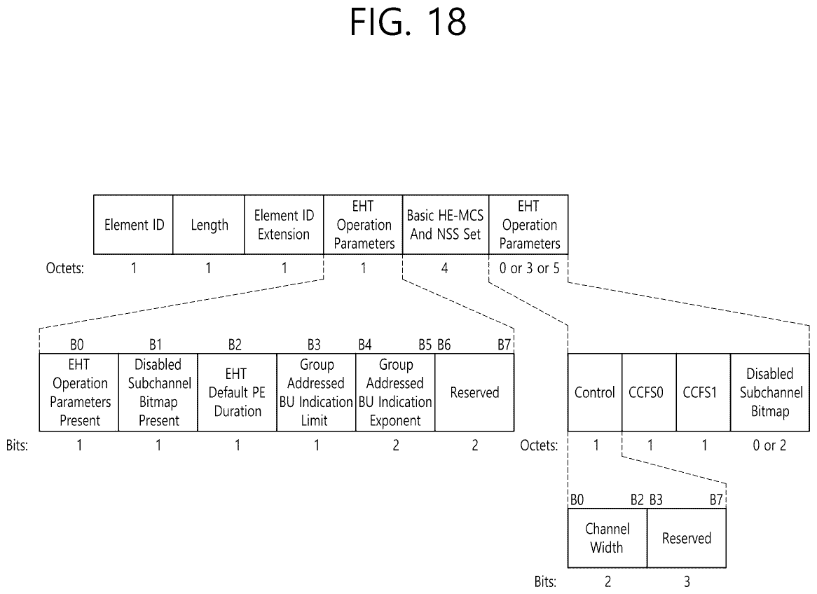

FIG. 18 shows the format of a modified EHT Operation element.

The EHT Operation element in FIG. 18 includes an EHT Operation Parameters field and an EHT Operation Information field, etc.

The EHT Operation Parameters field includes a EHT Operation Information Present subfield, Disabled Subchannel Bitmap Present subfield, EHT Default PE Duration subfield, Group Addressed BU Indication Limit subfield, and Group Addressed BU Indication Exponent subfield, etc.

When the EHT Operation Information Present subfield is 1, the EHT Operation Information field exists, and when the EHT Operation Information Present subfield is 0, the EHT Operation Information field does not exist.

If the channel width indicated in the HT Operation, VHT Operation, or HE Operation element existing in the same management frame is different from the Channel Width field indicated in the EHT Operation Information field, the EHT Operation Information Present subfield is set to 1.

If the EHT Operation Information field exists, the EHT STA obtains channel configuration information from the EHT Operation Information field in the EHT Operation element.

The EHT Operation Information field includes a Control subfield, CCFS0 subfield, CCFS1 subfield, and Disabled Subchannel Bitmap subfield. The Control subfield includes a Channel Width subfield.

The Channel Width subfield, the CCFS0 subfield, and the CCFS1 subfield are defined as follows.

| Subfield | Definition | Encoding |
|---|---|---|
| Channel Width | This subfield defines the EHT BSS | Set to 0 for 20M EHT BSS bandwidth. |
| | bandwidth. | Set to 1 for 40M EHT BSS bandwidth. |
| | | Set to 2 for 80M EHT BSS bandwidth. |
| | | Set to 3 for 160M EHT BSS bandwidth. |
| | | Set to 4 for 320M EHT BSS bandwidth. |
| | | Values in the ranges 5 to 7 are reserved. |
| CCFS0 | This subfield defines a channel center | For 20, 40 or 80M BSS bandwidth, |
| | frequency for a 20, 40, 80, 160, or | indicates the channel center frequency |
| | 320M EHT BBS. | index for the 20, 40 or 80M channel |
| | | on which the EHT BSS operates. |
| | | For 160M BSS bandwidth, indicates |
| | | the channel center frequency index of |
| | | the primary 80M channel. |
| | | For 320M BSS bandwidth, indicates |
| | | the channel center frequency index of |
| | | the primary 160M channel. |
| CCFS1 | This subfield defines a channel center | For a 20, 40 or 80M BSS bandwidth, |
| | frequency for a 160 or 320M EHT | this subfield is set to 0. |
| | BBS. | For a 160M BSS bandwidth, indicates |
| | | the channel center frequency index |
| | | of the 160M channel on which the EHT |
| | | BSS operates. |
| | | For a 320M BSS bandwidth, indicates |
| | | the channel center frequency index |
| | | of the 320M channel on which the EHT |
| | | BSS operates. |
| | | See Table EHT BSS channel width. |

Below shows the values of the Channel Width subfield and CCFS1 subfield according to the EHT BSS channel width.

| Channel Width | | EHT BSS channel |
|---|---|---|
| subfield | CCFS1 subfield | width (M) |
| 0 | 0 | 20 |
| 1 | 0 | 40 |
| 2 | 0 | 80 |
| 3 | CCFS1 > 0 and \|CCFS1 − | 160 |
| | CCFS0\| = 8 | |
| 4 | CCFS1 > 0 and \|CCFS1 − | 320 |
| | CCFS0] = 16 | |

### 3. SST(Subchannel Selective Transmission)

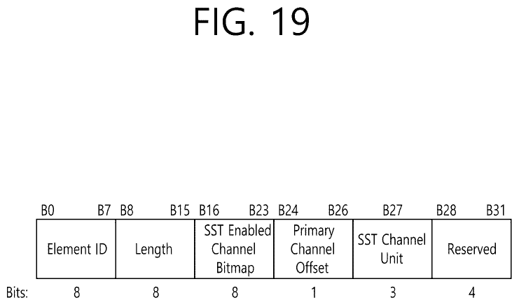

FIG. 19 shows the format of the SST Operation element.

Referring to FIG. 19, the SST Operation element includes an Element ID field, a Length field, an SST Enabled Channel Bitmap field, a Primary Channel Offset field, and an SST Channel Unit field.

The SST Enabled Channel Bitmap field includes a bitmap indicating channels that enable SST operation. Each bit of the bitmap corresponds to one channel width equal to the value of the SST Channel Unit field, along with the Least Significant Bit (LSB) corresponding to the lowest numbered subchannel in the SST Enabled Channel Bitmap field. The channel number of each channel in the SST Enabled Channel Bitmap field is equal to PCN minus OPC plus POS. The PCN is the value of the Primary Channel Number subfield in the recently transmitted STG Operation element, and the OPC is the value of the primary channel associated with the subchannel numbered with the lowest number in the bitmap specified by the value of the Primary Channel Number subfield. is the offset, and POS is the position of the channel in the bitmap. Setting the bit position of the bitmap to 1 indicates a subchannel that enables SST operation. At least one bit in the bitmap may be equal to 1.

The Primary Channel Offset field indicates the relative position of the primary channel with respect to/based on the channel numbered with the lowest number in the SST Enabled Channel Bitmap field. For example, setting the Primary Channel Offset field to 2 indicates that the primary channel is the third subchannel in the SST Enabled Channel Bitmap field.

The SST Channel Unit field indicates the channel width unit of each SST channel. Setting this field to 1 indicates that the channel width unit is 1 MHz, and setting this field to 0 indicates that the channel width unit is 2 MHz.

SST is defined in the 802.11ax (High Efficiency) wireless LAN system, and can be equally applied to future wireless LAN systems. Below, HE SST is described.

HE SST non-AP STA and HE SST AP can set SST operation by negotiating trigger-enabled Target Wakeup Time (TWT).

HE SST non-AP STAs and HE SST APs that have successfully configured SST operation must follow the following rules.

If the HE SST AP wants to change the operating channel or channel width, or the new operating channel or channel width does not belong to any secondary channel in the trigger-enabled TWT, the HE SST AP and HE SST non-AP STA implicitly trigger the trigger-enabled TWT can be terminated.

HE SST AP follows the rules defined in Individual TWT agreements to exchange frames with HE SST non-AP STAs during the trigger-enabled TWT.

The HE SST non-AP STA may include a Channel Switch Timing element in the (Re-)Association Request frame, and may transmit this to the HE SST AP to indicate the time requested by the STA for switching between different channels. The received channel switch time may inform the HE SST AP of the time duration during which the HE SST non-AP STA is not available to receive frames before the TWT start time and after the end of the trigger-enabled TWT SP.

In Power Saving (PS) mode, it is not required for the HE SST STA to move to the primary channel after the end of the trigger-enabled TWT SP.

### 4. Multi-AP System

Mesh Wi-Fi (Multi-AP solution) is well accepted in the market for better coverage, easy deployment and high throughput. It is desirable to improve the performance of Mesh Wi-Fi through joint optimization of MAC and PHY for Multi-AP systems.

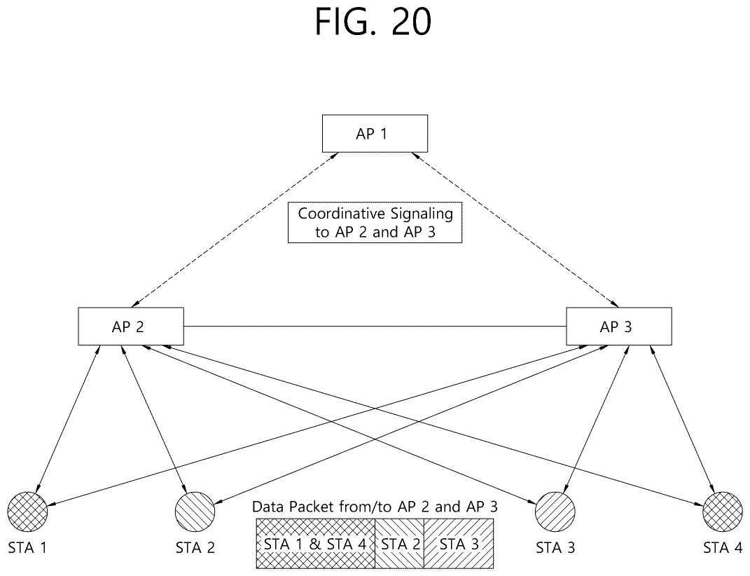

FIG. 20 shows the topology of the Multi-AP system.

FIG. 20 shows activation of joint Multi-AP transmission. Referring to FIG. 20, AP 1 sends a coordination signal to AP 2 and AP 3 to start joint transmission. AP 2 and AP 3 transmit and receive data to and from multiple STAs using OFDMA and MU-MIMO within one data packet. STA 2 and STA 3 are in different RUs, and each RU is a frequency segment. STA 1 and STA 4 are in the same resource unit using MU-MIMO. Each RU may be transmitted in multiple spatial streams.

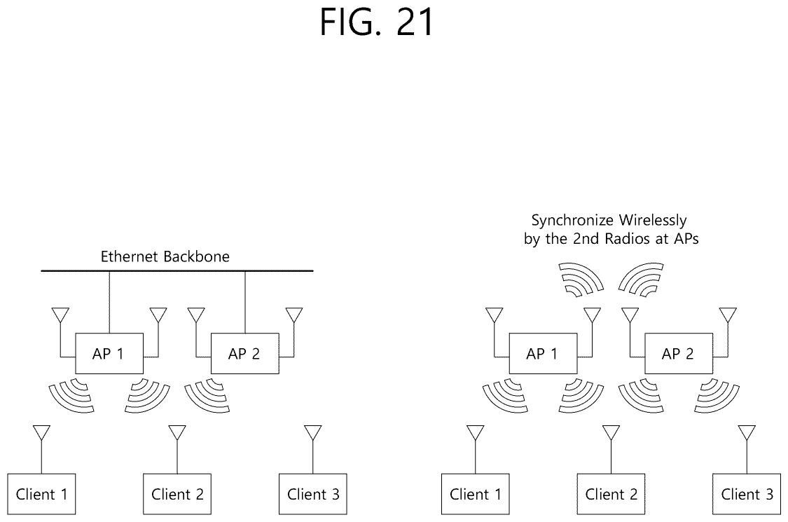

FIG. 21 is a diagram of coordination of Multi-AP.

Referring to FIG. 21, the Multi-AP system utilizes a wired (e.g. enterprise) or wireless (e.g. home mesh) backbone for data+clock synchronization, and limits link budget and regulated power better than a single AP with a large antenna array. Example technologies include Null Steering, joint beamforming, and joint MU-MIMO for interference avoidance.

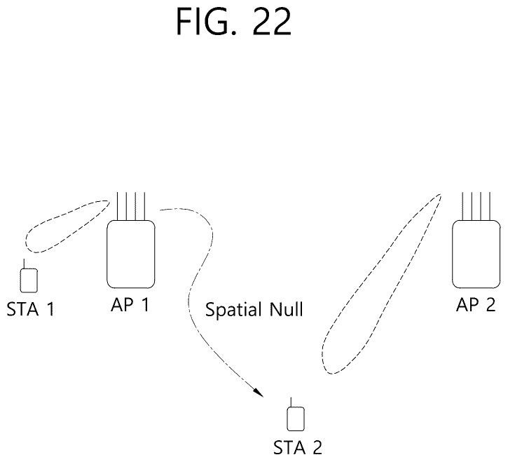

FIG. 22 shows interference avoidance steering of Multi-AP.

The interference avoidance steering of FIG. 22 is useful when the APs are of large dimensions (4×4 or 8×8).

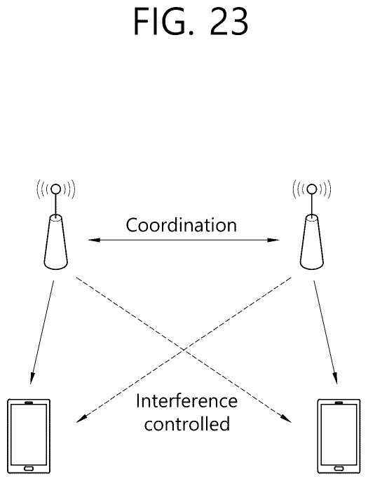

FIG. 23 shows AP coordination.

The coordinated scheduling in FIG. 23 mitigates/reduces the number of collisions of APs/STAs in different BSSs, implements a distributed mechanism, and increases the number/probability of parallel transmission in a more coordinated manner than spatial reuse. At this time, some message exchange between APs is necessary.

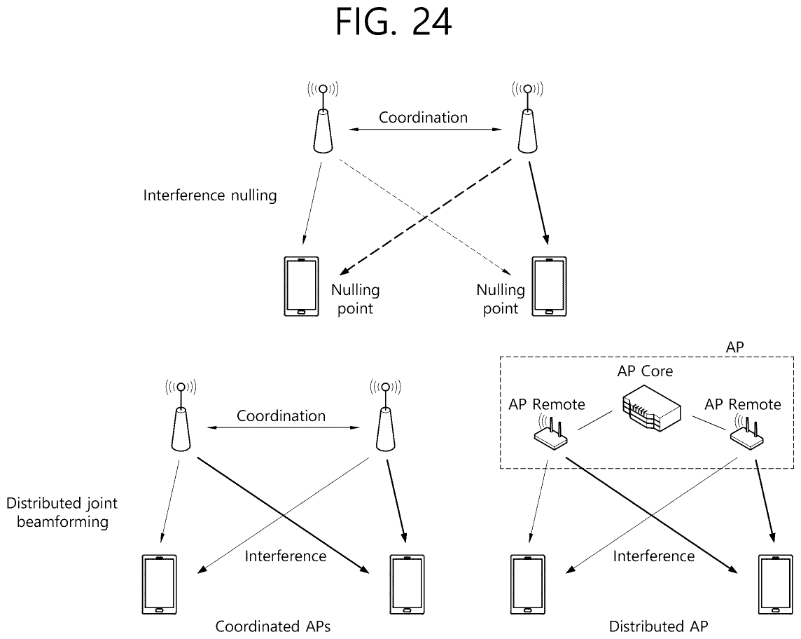

FIG. 24 shows coordinated beamforming.

FIG. 24 shows simultaneous downlink link transmission without co-channel interference due to beamforming or distributed joint beamforming, such as designating the nulling point to another STA.

For example, it is suitable for administrative arrangements such as corporate offices and hotels. Benefit from regional throughput and consistent user experience within a region. Coordinated downlink scheduling, improved MU sounding to reduce overhead, and synchronization are needed.

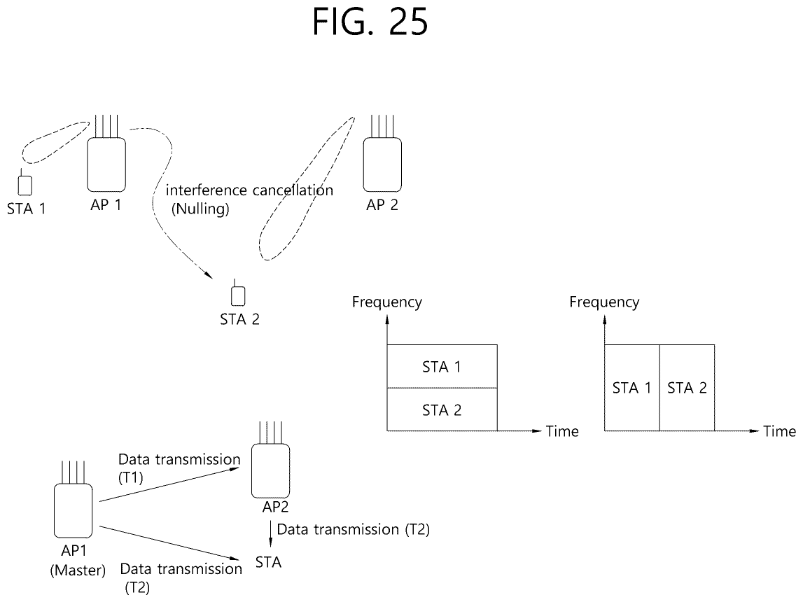

FIG. 25 shows an example of Multi-AP.

Referring to FIG. 25, Multi-AP is a technique for transmitting by coordinating multiple APs. For example, the techniques of Coordinated-Beamforming/Coordinated-OFDMA/Coordinated-TDMA/Coordinated-Spatial reuse/Joint transmission can be used.

Referring to the top of FIG. 25, AP1 can perform interference cancellation (nulling) for communication with AP2's STA2, and STAT and STA2 can be separated by time or frequency.

Referring to the bottom of FIG. 25, AP1 (Master AP) transmits data (T1) to AP2 (Slave AP) and data (T2) to STA, and AP2 may transmit data (T2) to STA2 based on the data (T1).

5. Embodiments Applicable to this Specification

In order to improve throughput, efficiency, transmission distance, latency, etc. in the wireless LAN 802.11 system, the Distributed Antenna System (DAS), in which the antennas of the AP are distributed and located within the BSS, can be considered. This specification proposes various primary channels and methods for indicating them in DAS.

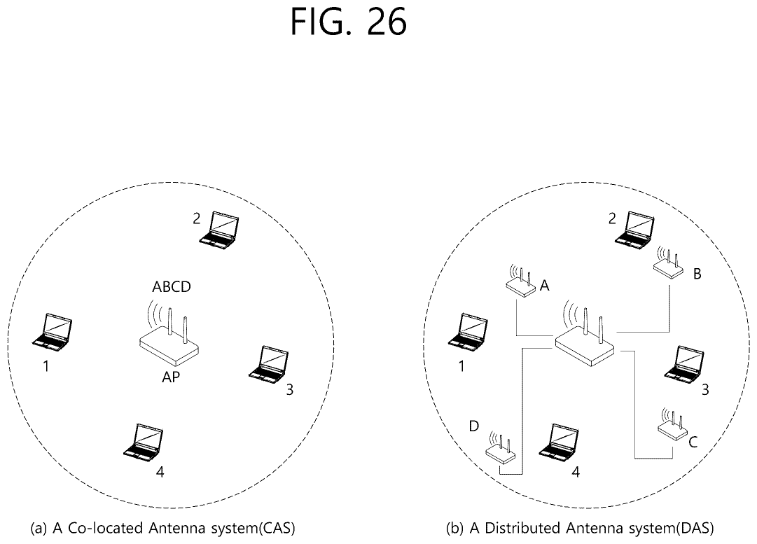

FIG. 26 is a diagram comparing CAS and DAS.

FIG. 26 is a diagram comparing the existing Co-located Antenna System (CAS), in which the AP's antenna is located in one place, and DAS, in which the antennas are distributed and located within the BSS.

The sub-drawing (a) of FIG. 26 shows CAS, and the sub-drawing (b) of FIG. 26 shows DAS.

In DAS, each antenna is connected (wired or wireless) to a central processor, and the central processor can form and process all signals when transmitting and receiving PPDUs, and each antenna can simply transmit and receive PPDUs. Additionally, each antenna can check CCA (Clear Channel Assessment) to determine whether a specific channel is busy/idle in each antenna.

Compared to existing CAS, DAS can ensure high SNR signal transmission because specific antennas and specific STAs can be located relatively close together. in particular, this environment can be provided to STAs located at the BSS edge. Additionally, since there are antennas that are relatively far away from the adjacent BSS, there is also the advantage of reducing interference to/from the adjacent BSS when using the corresponding antennas. However, since the busy/idle status of each antenna is different for each specific channel, the complexity of CCA and NAV (Network Allocation Vector) settings may increase, and additional mechanisms different from existing ones may be required. Although this is not covered in this specification, it is assumed that it is possible to determine whether a specific channel is busy or idle for each antenna.

In DAS, as before, a primary 20 MHz channel can exist within one BSS, and in this specification, it is called Primary_BSS. Additionally, an additional primary 20 MHz channel can be defined for each antenna and is named Primary_DAS. For example, in a DAS with antennas A, B, C, and D, as shown in FIG. 26 (b), the primary 20 MHz channels of each antenna can be defined as Primary_DAS_A, Primary_DAS_B, Primary_DAS_C, and Primary_DAS_D. The primary 20 MHz channel of each antenna may be the same or different from each other and may also be the same or different from Primary BSS.

Basically, CCA check and PPDU transmission operate based on Primary BSS. Additionally, Primary_DAS can always exist and be enabled only at a specific point in time. If it is always present, each antenna must be sensing Primary_BSS and Primary_DAS, so the burden on CCA check may increase and the method of processing signals when transmitting and receiving PPDU may be complicated and may not be efficient. Therefore, in this case, each antenna may operate only with Primary_DAS and may not have Primary_BSS, or the Primary_DAS of a specific antenna may be Primary BSS. Additionally, the Primary DAS of the corresponding antenna can be instructed to specific STAs adjacent to each antenna to operate based on the corresponding primary channel.

If Primary_DAS is enabled only at a specific time, CCA check operates based on Primary_DAS in each antenna, and the central processor can process the signal so that each antenna can form or receive a PPDU based on this. An embodiment of enabling at a specific point in time can be proposed. In a situation where TWT is applied similarly to SST, Primary_DAS can be defined for each antenna, and the STA adjacent to each antenna can be indicated to operate based on the corresponding primary 20 MHz. That is, each STA can obtain the effect of increasing throughput and reducing interference to/from other BSS by transmitting/receiving PPDU from adjacent antenna port based on Primary_DAS. In particular, this embodiment can reduce overhead and complexity during scheduling in AP through pairing between antenna port and STA during PPDU transmission/reception. Below, a procedure for pairing between STA and antenna port is proposed, and this can be defined similarly to the existing EHT TB sounding method. Hereinafter, the EHT sounding protocol is described.

### <EHT Sounding Protocol>

Transmit beamforming and DL MU-MIMO (DownLink Multi User-Multi Input Multi Output) require knowledge of channel conditions to calculate a steering matrix applied to the transmit signal to optimize reception at one or more receivers. The EHT STA determines channel state information using the EHT sounding protocol. The EHT sounding protocol provides explicit feedback mechanisms defined as EHT non-trigger-based (non-TB) sounding and EHT trigger-based (TB) sounding. Here, the EHT beamformee measures the channel using the training signal transmitted by the EHT beamformer (i.e., the EHT sounding NDP) and sends back a transformed estimate of the channel state. The EHT beamformer uses this estimate to derive a steering matrix.

The EHT beamformer returns an estimate of a channel state in an EHT compressed beamforming/CQI report included in one or more EHT Compressed Beamforming/CQI frames. There are three types of EHT compression beamforming/CQI report.

SU feedback: EHT compression beamforming/CQI report consists of an EHT compression beamforming report field.

-MU feedback: EHT compression beamforming/CQI report consists of an EHT compression beamforming report field and an EHT MU Exclusive beamforming report field.

CQI feedback: EHT compression beamforming/CQI report consists of an EHT CQI report field.

For reference, the use of EHT TB sounding does not necessarily mean MU feedback. EHT TB sounding is also used to obtain SU feedback and CQI feedback.

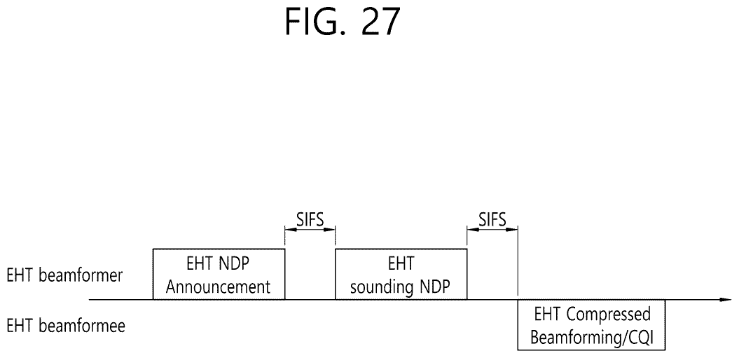

FIG. 27 shows an example of EHT non-TB sounding.

The EHT non-TB sounding sequence is initiated by the EHT beamformer using an individually addressed EHT NDP Announcement frame containing exactly one STA information field, and EHT sounding NDP is performed after SIFS. The EHT beamformer responds with an EHT Compressed Beamforming/CQI frame after SIFS.

The AID11 subfield of the STA information field must be set to the AID of the STA identified by the RA field of the EHT NDP Announcement frame, or set to 0 if the STA identified by the RA field is a mesh STA, AP, or IBSS STA.

An example of an EHT non-TB sounding sequence with a single EHT beamform is shown in FIG. 27.

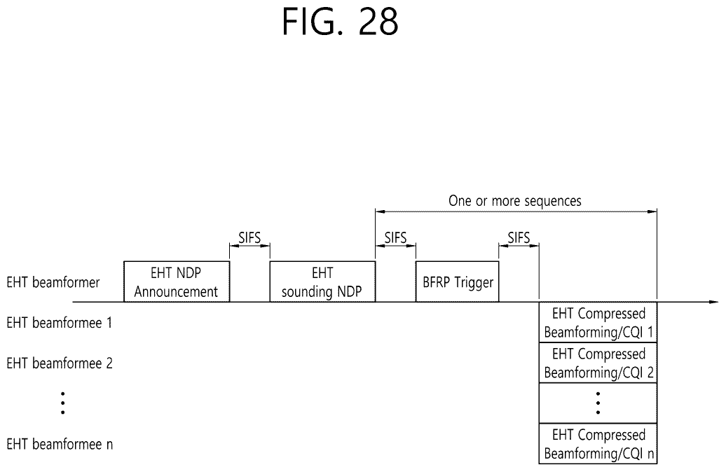

FIG. 28 shows an example of EHT TB sounding.

The EHT TB sounding sequence is initiated by the EHT beamformer using a broadcast EHT NDP Announcement frame with two or more STA information fields, an EHT sounding NDP is transmitted after the SIFS, and a BFRP (Beamforming Report) trigger frame following the SIFS is transmitted. The BFRP trigger frame transmitted within the EHT TB sounding sequence must request the EHT TB PPDU.

An example of an EHT TB sounding sequence with two or more EHT beamformes is shown in FIG. 28.

An EHT beamformer initiating an EHT TB sounding sequence must transmit an EHT NDP Announcement frame including two or more STA information fields and an RA field set to a broadcast address.

The EHT beamformer may initiate an EHT TB sounding sequence to request SU, MU or CQI feedback.

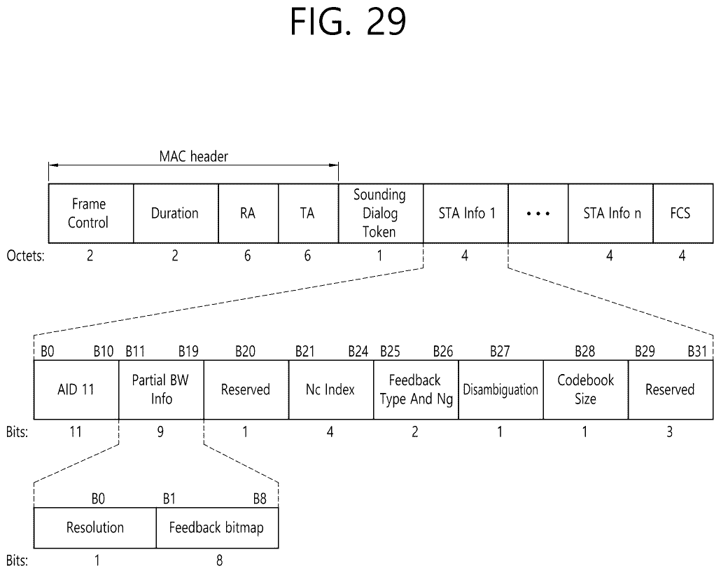

FIG. 29 shows an example of an EHT NDP Announcement frame format.

The VHT/HE/EHT NDP Announcement frame has three variants of a VHT NDP Announcement frame, a HE NDP Announcement frame, and an EHT NDP Announcement frame. Each variant is distinguished by the HE subfield setting and the Ranging subfield in the Sounding Dialog Token field.

The VHT/HE/EHT NDP Announcement frame includes at least one STA Info field. If the VHT/HE/EHT NDP Announcement frame includes only one STA Info field, the RA field is set to the address of an STA capable of providing feedback. If the VHT/HE/EHT NDP Announcement frame includes one or more STA Info fields, the RA field is set to a broadcast address.

The TA field is set to the address of the STA transmitting the VHT/HE/EHT NDP Announcement frame or the bandwidth signaling TA of the STA transmitting the VHT/HE/EHT NDP Announcement frame.

The Resolution subfield of the Partial BW Info subfield indicates the resolution bandwidth for each bit of the Feedback Bitmap subfield. The Feedback Bitmap subfield represents the request for each resolution bandwidth from the lowest frequency to the highest frequency, and B1 represents the lowest resolution bandwidth. Each bit in the Feedback Bitmap subfield is set to 1 when feedback is requested in the corresponding resolution bandwidth

EHT NDP Announcement frame contains at least one STA Info field per STA, but does not contain a STA Info field with an AID11 subfield greater than 2047.

5.1. Method 1: Transmit NDP in Sequence from Each Antenna Port

1) Transmit a frame (named DAS_NDPA, can be defined by another name) that initiates pairing between the antenna port and the STA.

DAS_NDPA (DAS Null Data Packet Announcement) can be transmitted simultaneously through all antenna ports in the Primary BSS. The DAS_NDPA can indicate the bandwidth (20 MHz) of the DAS_NDP or DAS_NDPA below and the number of antenna ports. The number of antenna ports is the same as the number of DAS_NDPs to be transmitted below.

In addition, the DAS_NDPA can indicate information such as feedback type, Ng, codebook size, etc., and if only RSSI (Received Signal Strength Indicator) or CQI (Channel Quality Indicator) information is requested, the information such as feedback type, Ng, codebook size, etc. may not be included.

The above DAS_NDPA must also indicate information of each STA to be given feedback, and like the existing NDPA (see FIG. 29), each STA Info field can be defined and the STA ID and the above information can be indicated separately in each STA Info field, but since all information except the STAID is the same, the STA Info field can be not specifically defined and can be indicated using each STA Info field. In addition, the number of STA ID fields can be variable, and in this case, the DAS_NDPA can indicate the number of STAs.

2) After SIFS (Short Interframe Space), PPDUs of a similar form to the existing NDP (named DAS_NDP, can be defined under a different name) are sequentially transmitted to each antenna port.

DAS_NDP can be transmitted through Primary_BSS or Primary_DAS, but since it is before pairing, transmission through Primary_DAS may not be desirable.

The interval of DAS_NDP transmitted from each antenna port can be SIFS, and the DAS_NDP format can be positioned in the order of legacy preamble and U-SIG (Universal-Signal) similar to the existing NDP, and the SIG of the new version Wi-Fi (UHR (Ultra High Reliability)) can be positioned thereafter, and a user specific field may not exist in the new version Wi-Fi SIG (UHR-SIG). In the DAS_NDP, a new version STF/LTF (UHR-STF/UHR-LTF) can be positioned after the new version Wi-Fi SIG, and a data field may not be positioned.

The number of LTF symbols can be 1 regardless of the number of antennas in the antenna port (in this case, only RSSI or CQI information can be requested in DAS_NDPA). Alternatively, the number of LTF symbols can be determined by the number of antennas in the antenna port (in this case, any feedback information requested in DAS_NDPA can be used). However, only one antenna can be selected for transmission in the antenna port, in which case the number of LTF symbols can always be 1 (in this case, too, any feedback information requested in DAS_NDPA can be used). Information about the number of LTF symbols can be indicated by the U-SIG or the SIG of the new version of Wi-Fi.

3) Transmit Trigger frame to receive feedback from each STA after SIFS

Similar to BFRP Trigger frame in the existing TB sounding (EHT sounding protocol) described above, the AP can transmit Trigger frame to STA to indicate RU/MRU (Resource Unit/Multi Resource Unit) information to transmit feedback information and synchronization information such as timing and transmission power.

4) After SIFS, each STA provides feedback using the allocated RU/MRU.

Each STA provides feedback information requested from DAS_NDPA via TB PPDU through the allocated RU/MRU, and at this time, transmits all feedback information obtained through DAS_NDP sent by each antenna port. With this information, the AP can decide which antenna port to pair with each STA.

### 5.2. Method 2: Each Antenna Port is Assigned a Specific Channel and Transmits One NDP

1) Transmits a frame (named DAS_NDPA, can be defined as another name) that initiates pairing between the antenna port and the STA

DAS_NDPA can be transmitted simultaneously through all antenna ports in the bandwidth of the DAS_NDP below, and can notify the bandwidth of the DAS_NDP or DAS_NDPA below, the number of antenna ports, and the channel information assigned to each antenna port.

The channel assigned to each antenna port is the channel through which the corresponding antenna port transmits DAS_NDP, and may be Primary_DAS, but is not limited thereto. In particular, considering the operating bandwidth of each STA, it may be desirable to allocate in units of RU/MRU that do not overlap between each antenna port within the Primary BSS, and depending on the number of antenna ports, it may be 26 tone RU or 52 tone RU, but it may also be allocated in units of smaller subcarriers. In this case, the bandwidth of DAS_NDPA and DAS_NDP may be 20 MHz. Alternatively, at least 26 tone RU may be allocated to each antenna port, in which case DAS_NDP may be transmitted at multiple timings depending on the number of antenna ports. In this case, antenna ports participating in DAS_NDP transmission at one timing may be allocated RU/MRUs of 26 tone or larger that do not overlap with each other.

In addition, the above DAS_NDPA may indicate information such as feedback type, Ng, and codebook size, and if only RSSI or CQI information is requested, the corresponding information (information such as feedback type, Ng, and codebook size) may not be included in the DAS_NDPA.

The DAS_NDPA must also indicate information of each STA to provide feedback, and like the existing NDPA, each STA Info field can be defined, and the STA ID and the above information can be indicated separately in each STA Info field, but since all information except the STA ID is the same, each corresponding field can be defined and indicated without specifically defining a STA Info field. In addition, the number of STA ID fields can be variable, and in this case, the DAS_NDPA can indicate the number of STAs.

2) After SIFS, PPDUs with a similar form to the existing NDP (named DAS_NDP, can be defined with a different name) are transmitted from each antenna port, and each antenna port transmits only on the assigned channel.

DAS_NDPs from each antenna port are transmitted only on the channel assigned to the corresponding antenna port (each channel can be Primary_DAS as described above, or a specific RU/MRU or subcarrier unit within Primary_BSS), but each DAS_NDP sent at the same timing can be temporally aligned. That is, unlike method 5.1, each DAS_NDP can be transmitted all at one timing (if the minimum unit of the channel assigned to each antenna port is limited, it can be transmitted at multiple timings), and each start and end time is the same, all fields and symbol boundaries can be the same, and the number of symbols can also be the same.

Each DAS_NDP type can be positioned in the order of legacy preamble and U-SIG similar to the existing NDP, and the SIG of the new version Wi-Fi can be positioned thereafter, and a user specific field may not exist in the new version Wi-Fi SIG. In the above DAS_NDP, the STF/LTF of the new version can be positioned after the new version Wi-Fi SIG, and the Data field may not be positioned. In the DAS_NDP, the legacy preamble and U-SIG can be transmitted in a 20 MHz bandwidth, and the STF/LTF of the new version may be transmitted in RU/MRU.

Also, phase rotation, STF/LTF sequence, etc. can be set considering the bandwidth of the entire DAS_NDP, and each antenna port can apply the corresponding sequence part within the channel allocated to it. However, if allocated in RU/MRU or subcarrier units within 20 MHz, the legacy preamble and U-SIG or SIG of new version Wi-Fi can be transmitted in 20 MHz units (i.e., the 20 MHz unit to which the allocated RU/MRU or subcarrier belongs), and only the STF/LTF of the new version can be transmitted in allocated RU/MRU or subcarrier units.

Also, the number of LTF symbols of DAS_NDP sent at the same timing can be determined based on the number of LTF symbols in the DAS_NDP of the antenna port with the most antennas, but if only RSSI or CQI feedback is requested, the number of LTF symbols can always be 1. However, only one antenna can be selected from the antenna port to transmit, in which case the number of LTF symbols can always be 1 (the feedback information requested by DAS NDPA can be any). Information about the number of LTF symbols can be indicated by the U-SIG or the SIG of the new version of Wi-Fi.

If the minimum unit of the channel allocated to each antenna port is limited, DAS_NDP can be transmitted at multiple timings, and each DAS_NDP transmitted at the same timing can be aligned as above, and the DAS_NDP of the next timing can be transmitted after SIFS after the end of DAS_NDP transmission of one timing.

3) Transmit Trigger frame to receive feedback from each STA after SIFS

Similar to the BFRP Trigger frame in the existing TB sounding (EHT sounding protocol) described above, the AP can transmit a Trigger frame to instruct the STA about the RU/MRU information to transmit feedback information and synchronization information such as timing and transmission power.

4) After SIFS, each STA feedbacks using the assigned RU/MRU

Each STA feedbacks the feedback information requested from DAS_NDPA via TB PPDU through the assigned RU/MRU, and transmits all feedback information obtained within the channel assigned to each antenna port. With this information, the AP can decide which antenna port to pair with each STA.

### 5.3. Method 3: MIMO (Multi Input Multi Output) NDP Transmission Considering the Number of Antennas in the Same Way as Before

1) Transmission of a frame (named DAS_NDPA, can be defined by another name) that initiates pairing between the antenna port and the STA

DAS_NDPA can be transmitted simultaneously through all antenna ports in Primary BSS and can indicate the bandwidth of DAS_NDP or DAS_NDPA (20 MHz) and the number of all antennas (not the number of antenna ports) below. If the number of antennas is greater than the dimension of the defined P matrix, it can mean that the DAS_NDP defined below is transmitted multiple times. For example, if the maximum dimension of the P matrix is 8 and the number of antennas is 12, two DAS_NDPs can be transmitted, the first DAS_NDP can be transmitted on 8 antennas and the second DAS_NDP can be transmitted on the remaining 4 antennas. In DAS, the concept of antenna port selection is applied so that when transmitting an actual PPDU, only some antenna ports with good channel conditions can be selected and used by considering the P matrix, and since multiple antenna ports can be deployed for optimal performance, a method in which multiple DAS NDPs are transmitted can be considered when considering this situation.

Alternatively, the DAS_NDPA can indicate the number of antenna ports instead of the number of antennas, and when transmitting DAS_NDP, only one antenna can transmit a signal from each antenna port, and the other antennas can be powered off. In this case as well, if the number of antenna ports is greater than the dimension of the defined P matrix, it can mean that DAS_NDP is transmitted multiple times, but there is room for reducing overhead compared to the method of transmitting according to the number of antennas.

In addition, the DAS_NDPA can indicate information such as feedback type, Ng, codebook size, etc., and it may not be possible to simply request RSSI information.

The DAS_NDPA must also indicate information of each STA to provide feedback, and like the existing NDPA, each STA Info field can be defined and the STA ID and the above information can be indicated separately in each STA Info field, but since all information except the STA ID is the same, each corresponding field can be defined and indicated without specifically defining the STA Info field. In addition, the number of STA ID fields can be variable, and in this case, the DAS_NDPA can indicate the number of STAs.

2) After SIFS, MIMO transmission considering all antennas or all antennas selected from each antenna port of PPDU (named DAS NDP) in a similar form to the existing NDP

DAS_NDP in MIMO form is transmitted from Primary BSS using all transmitted antennas. If multiple DAS_NDPs need to be sent, the interval between each DAS_NDP can be a SIFS difference.

Each DAS_NDP type can be positioned in the order of legacy preamble, U-SIG, similar to the existing NDP, and then the SIG of the new version Wi-Fi can be positioned, and there may be no user specific field in the new version Wi-Fi SIG. After that, the STF/LTF of the new version can be positioned, and the Data field may not be positioned.

The number of LTF symbols of each DAS_NDP can be set considering the number of antennas transmitting the corresponding DAS_NDP, and information about this can be indicated in the U-SIG of each DAS_NDP or the SIG of the new version Wi-Fi.

3) Transmit Trigger frame to receive feedback from each STA after SIFS

Similar to the BFRP Trigger frame in the existing TB sounding (EHT sounding protocol) described above, the AP can transmit a Trigger frame to instruct the STA about the RU/MRU information to transmit feedback information and synchronization information such as timing and transmission power.

4) After SIFS, each STA feedbacks using the assigned RU/MRU

Each STA feedbacks the feedback information requested from DAS_NDPA through TB PPDU through the assigned RU/MRU and transmits all feedback information obtained from each DAS_NDP. With this information, the AP can decide which antenna port to pair with each STA.

In terms of overhead, method 5.1 may have a disadvantage in that it has high overhead because each antenna port transmits DAS NDP at different times, and method 5.3 may also transmit multiple DAS_NDPs and may have multiple LTF symbols even when one DAS_NDP is transmitted. In contrast, method 5.2 may be advantageous in terms of overhead because it can transmit one DAS_NDP at the same time and set the LTF symbol to 1. Considering the case where the operating bandwidth of a specific STA that performs feedback is small, it may be advantageous to have a small total bandwidth of DAS_NDP, and also considering reliable performance, method 5.1 or method 5.3 may be advantageous. In method 5.2, if a wide channel is allocated to each antenna port for reliable channel state measurement, the bandwidth increases, so if an STA with a small operating bandwidth is participating in sounding, channel state measurement at the STA may not be possible. Considering this, a small channel can be allocated to each antenna port, but reliability in channel state measurement may deteriorate. Method 5.3 has the advantage of being able to make the most of the existing sounding method, but it may be difficult to use it as is when there are many antennas. In addition, unlike other methods, it can be relatively complicated because simple measurements such as RSSI are not possible (since the channel state for each antenna must be measured separately by ZF (Zero Forcing) or MMSE (Minimum Mean Square Error)).

In all the methods proposed above, if there are multiple antennas in each antenna port, it may be efficient to select only one antenna from each antenna port and transmit DAS_NDP to reduce the complexity according to the feedback measure and the DAS_NDP overhead and feedback overhead.

The AP can perform pairing between antenna ports and STAs by referring to the feedback information transmitted by each STA. The AP can pair one antenna port with each STA that is closest or has the best channel status, or it can pair multiple antenna ports with each STA, in which case it can select the antenna ports in the order of proximity or good channel status.

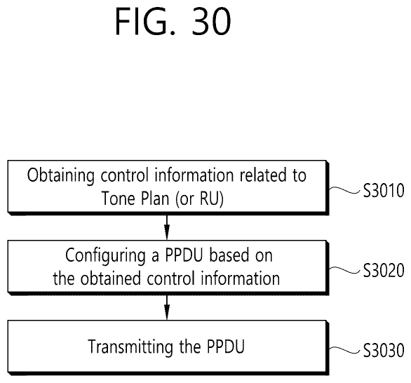

FIG. 30 is a flowchart illustrating the operation of the transmitting apparatus/device according to the present embodiment.

The example of FIG. 30 may be performed by a transmitting device (AP and/or non-AP STA).

Some of each step (or detailed sub-step to be described later) of the example of FIG. 30 may be skipped/omitted.

Through step S3010, the transmitting device (transmitting STA) may obtain information about the above-described tone plan. As described above, the information about the tone plan includes the size and location of the RU, control information related to the RU, information about a frequency band including the RU, information about an STA receiving the RU, and the like.

Through step S3020, the transmitting device may construct/generate a PPDU based on the acquired control information. Configuring/generating the PPDU may include configuring/generating each field of the PPDU. That is, step S3020 includes configuring the EHT-SIG field including control information about the tone plan. That is, step S3020 includes configuring a field including control information (e.g., N bitmap) indicating the size/position of the RU; and/or configuring a field including an identifier of an STA receiving the RU (e.g., AID).

Also, step S3020 may include generating an STF/LTF sequence transmitted through a specific RU. The STF/LTF sequence may be generated based on a preset STF generation sequence/LTF generation sequence.

Also, step S3020 may include generating a data field (i.e., MPDU) transmitted through a specific RU.

The transmitting device may transmit the PPDU constructed through step S2820 to the receiving device based on step S3030.

While performing step S3030, the transmitting device may perform at least one of operations such as CSD, Spatial Mapping, IDFT/IFFT operation, and GI insertion.

A signal/field/sequence constructed according to the present specification may be transmitted in the form of FIG. 10.

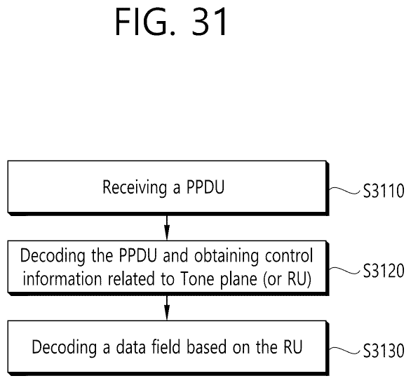

FIG. 31 is a flowchart illustrating the operation of the receiving apparatus/device according to the present embodiment.

The aforementioned PPDU may be received according to the example of FIG. 31.

The example of FIG. 31 may be performed by a receiving apparatus/device (AP and/or non-AP STA).

Some of each step (or detailed sub-step to be described later) of the example of FIG. 29 may be skipped/omitted.

The receiving device (receiving STA) may receive all or part of the PPDU through step S3010. The received signal may be in the form of FIG. 10.

A sub-step of step S3110 may be determined based on step S3030 of FIG. 30. That is, in step S3110, an operation of restoring the result of the CSD, Spatial Mapping, IDFT/IFFT operation, and GI insertion operation applied in step S3130 may be performed.

In step S3120, the receiving device may perform decoding on all/part of the PPDU. Also, the receiving device may obtain control information related to atone plan (i.e., RU) from the decoded PPDU.

More specifically, the receiving device may decode the L-SIG and EHT-SIG of the PPDU based on the legacy STF/LTF and obtain information included in the L-SIG and EHT SIG fields. Information on various tone plans (i.e., RUs) described in this specification may be included in the EHT-SIG, and the receiving STA may obtain information on the tone plan (i.e., RU) through the EHT-SIG.

In step S3130, the receiving device may decode the remaining part of the PPDU based on information about the tone plan (i.e., RU) acquired through step S3120. For example, the receiving STA may decode the STF/LTF field of the PPDU based on information about one plan (i.e., RU). In addition, the receiving STA may decode the data field of the PPDU based on information about the tone plan (i.e., RU) and obtain the MPDU included in the data field.

In addition, the receiving device may perform a processing operation of transferring the data decoded through step S3130 to a higher layer (e.g., MAC layer). In addition, when generation of a signal is instructed from the upper layer to the PHY layer in response to data transmitted to the upper layer, a subsequent operation may be performed.

Hereinafter, the above-described embodiment will be described with reference to FIG. 1 to FIG. 31.

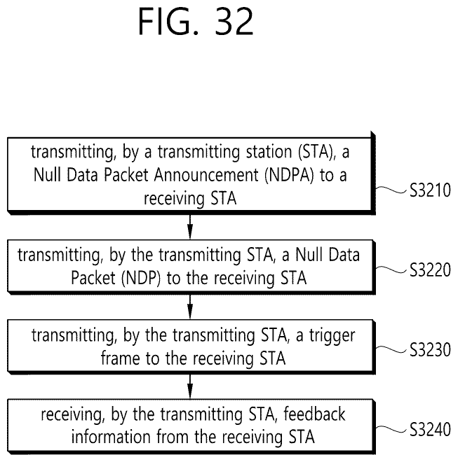

FIG. 32 is a flow diagram illustrating a procedure in which a transmitting STA measures a channel state for pairing between a distributed antenna port and a receiving STA in a DAS according to this embodiment.

The example of FIG. 32 may be performed in a network environment in which a next generation WLAN system (IEEE 802.11be or EHT WLAN system) is supported. The next generation wireless LAN system is a WLAN system that is enhanced from an 802.11ax system and may, therefore, satisfy backward compatibility with the 802.11ax system.

The example of FIG. 32 is performed at a transmitting STA, and the transmitting STA may correspond to an access point (AP) or a station (STA). Conversely, the receiving STA in FIG. 30 may correspond to an STA or an AP. When the transmitting STA is an AP and the receiving STA is an STA, a PPDU described later may be a downlink PPDU. When the transmitting STA is an STA and the receiving STA is an AP, a PPDU described later may be an uplink PPDU.

This embodiment proposes a sounding procedure for determining pairing between distributed antenna ports and receiving STAs for DAS transmission.

In step S3210, a transmitting station (STA) transmits a Null Data Packet Announcement (NDPA) to a receiving STA.

In step S3220, the transmitting STA transmits a Null Data Packet (NDP) to the receiving STA.

In step S3230, the transmitting STA transmits a trigger frame to the receiving STA.

In step S3240, the transmitting STA receives feedback information from the receiving STA.

The transmitting STA operates in a system in which a plurality of antenna ports are distributed.

The first primary 20 MHz channel is a primary 20 MHz channel that exists within one Basic Service Set (BSS). The one BSS may be a BSS of the transmitting STA. The second primary 20 MHz channel is an additional primary 20 MHz channel for each of the plurality of antenna ports.

The NDPA is transmitted simultaneously through the plurality of antenna ports. That is, the NDPA may be transmitted simultaneously through all antenna ports in a bandwidth of the NDP.

The NDPA includes information on a bandwidth of the NDPA or the NDP, a number of the plurality of antenna ports, and a channel allocated to the plurality of antenna ports. The bandwidth of the NDPA or the NDP may be 20 MHz.

The NDPA may request only Received Signal Strength Indicator (RSSI) information or Channel Quality Indicator (CQI) information, and may include information on a number of receiving STAs. At this time, the NDPA may not include information on feedback type, Ng, codebook size, etc.

The NDP may be transmitted through a channel assigned to the plurality of antenna ports. The channel assigned to the plurality of antenna ports may be a first Resource Unit (RU) or a first Multi Resource Unit (MRU) that does not overlap between each antenna port within the first primary 20 MHz channel. At this time, The first RU or the first MRU may have a size of at least 26 tones.

The NDP may include a legacy preamble, a Universal-Signal (U-SIG), an Ultra High Reliability-Short Training Field (UHR-STF), and an Ultra High Reliability-Long Training Field (UHR-LTF).

The legacy preamble and the U-SIG may be transmitted through the 20 MHz. The UHR-STF and the UHR-LTF may be transmitted through the first RU or the first MRU based on the NDPA.

A number of symbols of the UHR-LTF may be 1. This is because the NDPA requests to feed back only RSSI or CQI. However, the NDP may be transmitted by selecting only one antenna from each of the plurality of antenna ports.

The NDP may be transmitted at the same time for the plurality of antenna ports or transmitted at specific times.

Based on the NDP being transmitted at the same time for the plurality of antenna ports, boundaries of fields and symbols in the NDP transmitted to the plurality of antenna ports may be the same, and a number of symbols in the NDP transmitted to the plurality of antenna ports may be the same.

Based on the NDP being transmitted at the specific times, the specific time may be Short Interframe Space (SIFS). That is, the second NDP may be transmitted after SIFS after a transmission of the first NDP is finished.

The trigger frame may include information on a time to transmit the feedback information, information on a second RU or a second MRU to transmit the feedback information, transmission power, and synchronization information. The feedback information may be received through the second RU or the second MRU.

The transmitting STA may determine pairing of the plurality of antenna ports and the receiving STA based on the feedback information. The receiving STA receives information on pairing of the plurality of antenna ports and the receiving STA determined based on the feedback information. This has the effect of efficiently supporting DAS and improving throughput and latency performance through extension of transmission distance. In addition, there is an advantage that the transmitting STA may send a signal to the receiving STA at a closer distance through DAS. The plurality of antenna ports are wired to the transmitting STA.

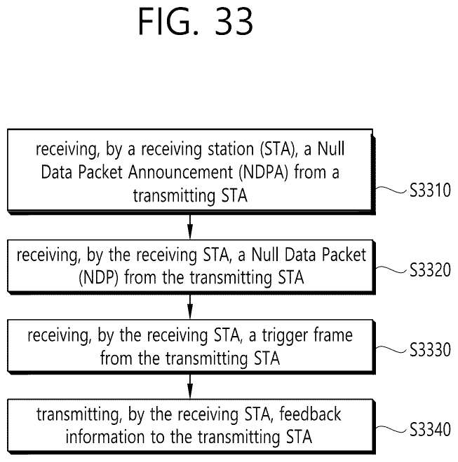

FIG. 33 is a flow diagram illustrating a procedure in which a receiving STA feed backs a channel state for pairing between a receiving STA and a distributed antenna port in a DAS according to this embodiment.

The example of FIG. 33 may be performed in a network environment in which a next generation WLAN system (IEEE 802.11be or EHT WLAN system) is supported. The next generation wireless LAN system is a WLAN system that is enhanced from an 802.11ax system and may, therefore, satisfy backward compatibility with the 802.11ax system.

The example of FIG. 33 is performed at a receiving STA, and the receiving STA may correspond to a station (STA) or an access point (AP). Conversely, the transmitting STA in FIG. 31 may correspond to an AP or STA. When the transmitting STA is an AP and the receiving STA is an STA, a PPDU described later may be a downlink PPDU. When the transmitting STA is an STA and the receiving STA is an AP, a PPDU described later may be an uplink PPDU.

This embodiment proposes a sounding procedure for determining pairing between distributed antenna ports and receiving STAs for DAS transmission.

In step S3310, a receiving station (STA) receives a Null Data Packet Announcement (NDPA) from a transmitting STA.

In step S3320, the receiving STA receives a Null Data Packet (NDP) from the transmitting STA.

In step S3330, the receiving STA receives a trigger frame from the transmitting STA.

In step S3340, the receiving STA transmits feedback information to the transmitting STA.

The transmitting STA operates in a system in which a plurality of antenna ports are distributed.

The first primary 20 MHz channel is a primary 20 MHz channel that exists within one Basic Service Set (BSS). The one BSS may be a BSS of the transmitting STA. The second primary 20 MHz channel is an additional primary 20 MHz channel for each of the plurality of antenna ports.

The NDPA is transmitted simultaneously through the plurality of antenna ports. That is, the NDPA may be transmitted simultaneously through all antenna ports in a bandwidth of the NDP.

The NDPA includes information on a bandwidth of the NDPA or the NDP, a number of the plurality of antenna ports, and a channel allocated to the plurality of antenna ports. The bandwidth of the NDPA or the NDP may be 20 MHz.

The NDPA may request only Received Signal Strength Indicator (RSSI) information or Channel Quality Indicator (CQI) information, and may include information on a number of receiving STAs. At this time, the NDPA may not include information on feedback type, Ng, codebook size, etc.

The NDP may be transmitted through a channel assigned to the plurality of antenna ports. The channel assigned to the plurality of antenna ports may be a first Resource Unit (RU) or a first Multi Resource Unit (MRU) that does not overlap between each antenna port within the first primary 20 MHz channel. At this time, The first RU or the first MRU may have a size of at least 26 tones.

The NDP may include a legacy preamble, a Universal-Signal (U-SIG), an Ultra High Reliability-Short Training Field (UHR-STF), and an Ultra High Reliability-Long Training Field (UHR-LTF).

The legacy preamble and the U-SIG may be transmitted through the 20 MHz. The UHR-STF and the UHR-LTF may be transmitted through the first RU or the first MRU based on the NDPA.

A number of symbols of the UHR-LTF may be 1. This is because the NDPA requests to feed back only RSSI or CQI. However, the NDP may be transmitted by selecting only one antenna from each of the plurality of antenna ports.

The NDP may be transmitted at the same time for the plurality of antenna ports or transmitted at specific times.

Based on the NDP being transmitted at the same time for the plurality of antenna ports, boundaries of fields and symbols in the NDP transmitted to the plurality of antenna ports may be the same, and a number of symbols in the NDP transmitted to the plurality of antenna ports may be the same.

Based on the NDP being transmitted at the specific times, the specific time may be Short Interframe Space (SIFS). That is, the second NDP may be transmitted after SIFS after a transmission of the first NDP is finished.

The trigger frame may include information on a time to transmit the feedback information, information on a second RU or a second MRU to transmit the feedback information, transmission power, and synchronization information. The feedback information may be received through the second RU or the second MRU.

The transmitting STA may determine pairing of the plurality of antenna ports and the receiving STA based on the feedback information. The receiving STA receives information on pairing of the plurality of antenna ports and the receiving STA determined based on the feedback information. This has the effect of efficiently supporting DAS and improving throughput and latency performance through extension of transmission distance. In addition, there is an advantage that the transmitting STA may send a signal to the receiving STA at a closer distance through DAS. The plurality of antenna ports are wired to the transmitting STA.

### 6. Device Configuration

The technical features of the present disclosure may be applied to various devices and methods. For example, the technical features of the present disclosure may be performed/supported through the device(s) of FIG. 1 and/or FIG. 11. For example, the technical features of the present disclosure may be applied to only part of FIG. 1 and/or FIG. 11. For example, the technical features of the present disclosure may be implemented based on the processing chip(s) 114 and 124 of FIG. 1, or implemented based on the processor(s) 111 and 121 and the memory(s) 112 and 122, or implemented based on the processor 610 and the memory 620 of FIG. 11. For example, the device according to the present disclosure transmits a Null Data Packet Announcement (NDPA) to a receiving STA; transmits a Null Data Packet (NDP) to the receiving STA; transmits a trigger frame to the receiving STA; and receives feedback information from the receiving STA.

The technical features of the present disclosure may be implemented based on a computer readable medium (CRM). For example, a CRM according to the present disclosure is at least one computer readable medium including instructions designed to be executed by at least one processor.

The CRM may store instructions that perform operations including receiving a Null Data Packet Announcement (NDPA) from a transmitting station (STA); receiving a Null Data Packet (NDP) from the transmitting STA; receiving a trigger frame from the transmitting STA; and transmitting feedback information to the transmitting STA. At least one processor may execute the instructions stored in the CRM according to the present disclosure. At least one processor related to the CRM of the present disclosure may be the processor 111, 121 of FIG. 1, the processing chip 114, 124 of FIG. 1, or the processor 610 of FIG. 11. Meanwhile, the CRM of the present disclosure may be the memory 112, 122 of FIG. 1, the memory 620 of FIG. 11, or a separate external memory/storage medium/disk.

The foregoing technical features of the present specification are applicable to various applications or business models. For example, the foregoing technical features may be applied for wireless communication of a device supporting artificial intelligence (AI).

Artificial intelligence refers to a field of study on artificial intelligence or methodologies for creating artificial intelligence, and machine learning refers to a field of study on methodologies for defining and solving various issues in the area of artificial intelligence. Machine learning is also defined as an algorithm for improving the performance of an operation through steady experiences of the operation.

An artificial neural network (ANN) is a model used in machine learning and may refer to an overall problem-solving model that includes artificial neurons (nodes) forming a network by combining synapses. The artificial neural network may be defined by a pattern of connection between neurons of different layers, a learning process of updating a model parameter, and an activation function generating an output value.

The artificial neural network may include an input layer, an output layer, and optionally one or more hidden layers. Each layer includes one or more neurons, and the artificial neural network may include synapses that connect neurons. In the artificial neural network, each neuron may output a function value of an activation function of input signals input through a synapse, weights, and deviations.

A model parameter refers to a parameter determined through learning and includes a weight of synapse connection and a deviation of a neuron. A hyper-parameter refers to a parameter to be set before learning in a machine learning algorithm and includes a learning rate, the number of iterations, a mini-batch size, and an initialization function.

Learning an artificial neural network may be intended to determine a model parameter for minimizing a loss function. The loss function may be used as an index for determining an optimal model parameter in a process of learning the artificial neural network.

Machine learning may be classified into supervised learning, unsupervised learning, and reinforcement learning.

Supervised learning refers to a method of training an artificial neural network with a label given for training data, wherein the label may indicate a correct answer (or result value) that the artificial neural network needs to infer when the training data is input to the artificial neural network. Unsupervised learning may refer to a method of training an artificial neural network without a label given for training data. Reinforcement learning may refer to a training method for training an agent defined in an environment to choose an action or a sequence of actions to maximize a cumulative reward in each state.

Machine learning implemented with a deep neural network (DNN) including a plurality of hidden layers among artificial neural networks is referred to as deep learning, and deep learning is part of machine learning. Hereinafter, machine learning is construed as including deep learning.

The foregoing technical features may be applied to wireless communication of a robot.

Robots may refer to machinery that automatically process or operate a given task with own ability thereof. In particular, a robot having a function of recognizing an environment and autonomously making a judgment to perform an operation may be referred to as an intelligent robot.

Robots may be classified into industrial, medical, household, military robots and the like according uses or fields. A robot may include an actuator or a driver including a motor to perform various physical operations, such as moving a robot joint. In addition, a movable robot may include a wheel, a brake, a propeller, and the like in a driver to run on the ground or fly in the air through the driver.

The foregoing technical features may be applied to a device supporting extended reality.

Extended reality collectively refers to virtual reality (VR), augmented reality (AR), and mixed reality (MR). VR technology is a computer graphic technology of providing a real-world object and background only in a CG image, AR technology is a computer graphic technology of providing a virtual CG image on a real object image, and MR technology is a computer graphic technology of providing virtual objects mixed and combined with the real world.

MR technology is similar to AR technology in that a real object and a virtual object are displayed together. However, a virtual object is used as a supplement to a real object in AR technology, whereas a virtual object and a real object are used as equal statuses in MR technology.

XR technology may be applied to a head-mount display (HMD), a head-up display (HUD), a mobile phone, a tablet PC, a laptop computer, a desktop computer, a TV, digital signage, and the like. A device to which XR technology is applied may be referred to as an XR device.

The claims recited in the present specification may be combined in a variety of ways. For example, the technical features of the method claims of the present specification may be combined to be implemented as a device, and the technical features of the device claims of the present specification may be combined to be implemented by a method. In addition, the technical characteristics of the method claim of the present specification and the technical characteristics of the device claim may be combined to be implemented as a device, and the technical characteristics of the method claim of the present specification and the technical characteristics of the device claim may be combined to be implemented by a method.

1. A method in a wireless local area network (WLAN) system, the method comprising:
receiving, by a receiving station (STA), a Null Data Packet Announcement (NDPA) from a transmitting STA;
receiving, by the receiving STA, a Null Data Packet (NDP) from the transmitting STA;
receiving, by the receiving STA, a trigger frame from the transmitting STA; and
transmitting, by the receiving STA, feedback information to the transmitting STA,
wherein the transmitting STA operates in a system in which a plurality of antenna ports are distributed,
wherein the first primary 20 MHz channel is a primary 20 MHz channel that exists within one Basic Service Set (BSS),
wherein the second primary 20 MHz channel is an additional primary 20 MHz channel for each of the plurality of antenna ports,
wherein the NDPA is transmitted simultaneously through the plurality of antenna ports, and
wherein the NDPA includes information on a bandwidth of the NDPA or the NDP, a number of the plurality of antenna ports, and a channel allocated to the plurality of antenna ports.

2. The method of claim 1, wherein the NDPA requests only Received Signal Strength Indicator (RSSI) information or Channel Quality Indicator (CQI) information, and includes information on a number of receiving STAs,
wherein the bandwidth of the NDPA or the NDP is 20 MHz.

3. The method of claim 2, wherein the NDP is transmitted through a channel assigned to the plurality of antenna ports,
wherein the channel assigned to the plurality of antenna ports is a first Resource Unit (RU) or a first Multi Resource Unit (MRU) that does not overlap between each antenna port within the first primary 20 MHz channel,
wherein the first RU or the first MRU has a size of at least 26 tones.

4. The method of claim 3, wherein the NDP includes a legacy preamble, a Universal-Signal (U-SIG), an Ultra High Reliability-Short Training Field (UHR-STF), and an Ultra High Reliability-Long Training Field (UHR-LTF), and
wherein the legacy preamble and the U-SIG are transmitted through the 20 MHz,
wherein the UHR-STF and the UHR-LTF are transmitted through the first RU or the first MRU based on the NDPA,
wherein a number of symbols of the UHR-LTF is 1.

5. The method of claim 4, wherein the NDP is transmitted at the same time for the plurality of antenna ports or transmitted at specific times, and
wherein based on the NDP being transmitted at the same time for the plurality of antenna ports, boundaries of fields and symbols in the NDP transmitted to the plurality of antenna ports are the same, and a number of symbols in the NDP transmitted to the plurality of antenna ports are the same, and
wherein based on the NDP being transmitted at the specific times, the specific time is Short Interframe Space (SIFS).

6. The method of claim 5, wherein the trigger frame includes information on a time to transmit the feedback information, information on a second RU or a second MRU to transmit the feedback information, transmission power, and synchronization information, and
wherein the feedback information is received through the second RU or the second MRU.

7. The method of claim 6, further comprising:
receiving, by the receiving STA, information on pairing of the plurality of antenna ports and the receiving STA determined based on the feedback information.

8. A receiving station (STA) in a wireless local area network (WLAN) system, the receiving STA comprising:
a memory;
a transceiver; and
a processor being operatively connected to the memory and the transceiver,
wherein the processor is configured to:
receive a Null Data Packet Announcement (NDPA) from a transmitting STA;
receive a Null Data Packet (NDP) from the transmitting STA;
receive a trigger frame from the transmitting STA; and
transmit feedback information to the transmitting STA,
wherein the transmitting STA operates in a system in which a plurality of antenna ports are distributed,
wherein the first primary 20 MHz channel is a primary 20 MHz channel that exists within one Basic Service Set (BSS),
wherein the second primary 20 MHz channel is an additional primary 20 MHz channel for each of the plurality of antenna ports,
wherein the NDPA is transmitted simultaneously through the plurality of antenna ports, and
wherein the NDPA includes information on a bandwidth of the NDPA or the NDP, a number of the plurality of antenna ports, and a channel allocated to the plurality of antenna ports.

9. A method in a wireless local area network (WLAN) system, the method comprising:
transmitting, by a transmitting station (STA), a Null Data Packet Announcement (NDPA) to a receiving STA;
transmitting, by the transmitting STA, a Null Data Packet (NDP) to the receiving STA;
transmitting, by the transmitting STA, a trigger frame to the receiving STA; and
receiving, by the transmitting STA, feedback information from the receiving STA, wherein the transmitting STA operates in a system in which a plurality of antenna ports are distributed,
wherein the first primary 20 MHz channel is a primary 20 MHz channel that exists within one Basic Service Set (BSS),
wherein the second primary 20 MHz channel is an additional primary 20 MHz channel for each of the plurality of antenna ports,
wherein the NDPA is transmitted simultaneously through the plurality of antenna ports, and
wherein the NDPA includes information on a bandwidth of the NDPA or the NDP, a number of the plurality of antenna ports, and a channel allocated to the plurality of antenna ports.

10. The method of claim 9, wherein the NDPA requests only Received Signal Strength Indicator (RSSI) information or Channel Quality Indicator (CQI) information, and includes information on a number of receiving STAs,
wherein the bandwidth of the NDPA or the NDP is 20 MHz.

11. The method of claim 10, wherein the NDP is transmitted through a channel assigned to the plurality of antenna ports,
wherein the channel assigned to the plurality of antenna ports is a first Resource Unit (RU) or a first Multi Resource Unit (MRU) that does not overlap between each antenna port within the first primary 20 MHz channel,
wherein the first RU or the first MRU has a size of at least 26 tones.

12. The method of claim 11, wherein the NDP includes a legacy preamble, a Universal-Signal (U-SIG), an Ultra High Reliability-Short Training Field (UHR-STF), and an Ultra High Reliability-Long Training Field (UHR-LTF), and
wherein the legacy preamble and the U-SIG are transmitted through the 20 MHz,
wherein the UHR-STF and the UHR-LTF are transmitted through the first RU or the first MRU based on the NDPA,
wherein a number of symbols of the UHR-LTF is 1.

13. The method of claim 12, wherein the NDP is transmitted at the same time for the plurality of antenna ports or transmitted at specific times, and
wherein based on the NDP being transmitted at the same time for the plurality of antenna ports, boundaries of fields and symbols in the NDP transmitted to the plurality of antenna ports are the same, and a number of symbols in the NDP transmitted to the plurality of antenna ports are the same, and
wherein based on the NDP being transmitted at the specific times, the specific time is Short Interframe Space (SIFS).

14. The method of claim 13, wherein the trigger frame includes information on a time to transmit the feedback information, information on a second RU or a second MRU to transmit the feedback information, transmission power, and synchronization information, and
wherein the feedback information is received through the second RU or the second MRU.

15. The method of claim 14, further comprising:
determining, by the transmitting STA, pairing of the plurality of antenna ports and the receiving STA based on the feedback information.

16-18. (canceled)
